(19) United States
(12) Patent Application Publication
(10) Pub. No.: US 2026/0006345 A1
(43) Pub. Date: Jan. 1, 2026

(54) METHOD OF DETERMINING DIRECTION OF GAZE, ELECTRONIC DEVICE, AND STORAGE MEDIUM

(71) Applicant: SAMSUNG ELECTRONICS CO., LTD., Suwon-si (KR)

(72) Inventors: Lin MA, Beijing (CN); Weiming LI, Beijing (CN); Chaoqun ZHUANG, Beijing (CN); Jingrui SONG, Beijing (CN); Qiang WANG, Beijing (CN); Soonyong CHO, Beijing (CN); Younghun SUNG, Beijing (CN)

(73) Assignee: SAMSUNG ELECTRONICS CO., LTD., Suwon-si (KR)

(21) Appl. No.: 19/253,469

(22) Filed: Jun. 27, 2025

(30) Foreign Application Priority Data
Jun. 28, 2024 (CN) 202410868600.3
Nov. 15, 2024 (KR) 10-2024-0163343

(51) Int. Cl. H04N 25/47; G06F 3/01; G06T 5/70; G06T 7/73

(52) U.S. Cl. CPC H04N 25/47; G06F 3/013; G06T 5/70; G06T 7/73; G06T 2207/30196

(57) ABSTRACT

Provided is a method of determining a gaze direction including obtaining a plurality of image frames by performing decoding based on data acquired by an event camera, determining reflected light point information for each image frame among the plurality of image frames, and determining the gaze direction for each image frame among the plurality of image frames based on the reflected light point information, wherein each image frame among the plurality of image frames includes event data obtained based on a reflected light point signal captured by the event camera, the reflected light point signal being light that is emitted from a light source and is reflected by a corneal surface, and wherein the reflected light point information includes at least one of a reflected light point position and numbers of reflected light points corresponding to a pair of reflected light points obtained based on the event data.

### CROSS-REFERENCE TO RELATED APPLICATION

This application claims priority to Korean Patent Application No. 10-2024-0163343, filed on Nov. 15, 2024, in the Korean Intellectual Property Office, and Chinese Patent Application No. 202410868600.3, filed on Jun. 28, 2024, in the State Intellectual Property Office (SIPO) of the People's Republic of China, the disclosures of which are incorporated by reference herein in their entireties.

### BACKGROUND

### 1. Field

Embodiments of the present disclosure relate to the field of gaze estimation, and more particularly, to a method of determining a gaze direction, an electronic device, and a storage medium.

### 2. Description of Related Art

High-efficiency gaze estimation is very important in the field of extended reality (XR), which includes virtual reality (VR), augmented reality (AR), and mixed reality (MR), and provides a high-efficiency human-computer interaction method. Because gaze estimation has relatively high requirements for speed and power consumption, it is expected to implement gaze estimation with low latency and low cost.

### SUMMARY

One or more embodiments provide a method of determining a gaze direction, an electronic device, and a storage medium to at least solve the problems of the related art.

Additional aspects will be set forth in part in the description which follows and, in part, will be apparent from the description, or may be learned by practice of embodiments of the disclosure.

According to an aspect of one or more embodiments, there is provided a method of determining a gaze direction, the method including obtaining a plurality of image frames by performing decoding based on data acquired by an event camera, determining reflected light point information for each image frame among the plurality of image frames, and determining the gaze direction for each image frame among the plurality of image frames based on the reflected light point information, wherein each image frame among the plurality of image frames includes event data obtained based on a reflected light point signal captured by the event camera, the reflected light point signal being light that is emitted from a light source and is reflected by a corneal surface, and wherein the reflected light point information includes at least one of a reflected light point position and numbers of reflected light points corresponding to a pair of reflected light points obtained based on the event data.

The event camera may include a dynamic vision sensor (DVS) camera based on camera parallel interface (CPI).

The determining of the reflected light point information for each image frame among the plurality of image frames may include determining a first frame among a set of image frames included in a same cycle based on time information corresponding to the plurality of image frames, sequentially obtaining whether one image frame among the first frame and a second frame of the plurality of image frames satisfies a requirement, and determining the reflected light point information for each image frame among the plurality of image frames after the one image frame among the set of image frames, based on the one image frame among the first frame and the second frame satisfying the requirement.

The sequentially determining whether the one image frame among the first frame and the second frame satisfies the requirement of an image frame set may include detecting a pair of reflected light points corresponding to the light source from the first frame, based on a first approximate circle approximated to the pair of reflected light points of the first frame being valid and a number of pairs of the reflected light points of the first frame being greater than or equal to a first threshold, determining that the first frame satisfies the requirement, based on determining the first frame does not satisfy the requirement, detecting a pair of reflected light points corresponding to the light source from the second frame of the image frame set, and based on the first approximate circle approximated to a pair of reflected light points of the second frame being valid and a number of the pairs of reflected light points of the second frame being greater than or equal to a second threshold, determining that the second frame satisfies the requirement.

Based on the reflected light point information, the determining of the gaze direction for each image frame may include based on none of the first frame and the second frame satisfying the requirement, for each image frame among the image frame set, based on a first approximate circle obtained based on the reflected light point information of a current image frame being valid, determining the gaze direction for the current image frame based on the first approximate circle based on a second regression model, and based on the first approximate circle being invalid, determining the gaze direction for the current image frame as the gaze direction for a previous image frame.

Based on the time information corresponding to the plurality of image frames, the determining of the first frame among the plurality of image frames included in the same cycle may include, based on the time information of the current image frame being greater than the time information of the next image frame or a time interval between a current image frame and a next image frame being greater than a third threshold, determining the next image frame as the first frame among the image frame set.

The detecting of the pair of reflected light points corresponding to the light source from the first frame may include, based on a pair of reflected light points corresponding to the number of light sources being not detected from a previous image frame of a current image frame, detecting the pair of reflected light points corresponding to the light source in the current image frame, and the current image frame may be the first frame or the second frame.

The determining of the reflected light point information for each image frame among the plurality of image frames may include determining a pair of reflected light points corresponding to the light source in a current image frame, and determining the reflected light point information of a first reflected light point among each pair of reflected light points, wherein the reflected light point position corresponds to a pixel position of the first reflected light point in the current image frame.

Based on the reflected light point information, the determining of the gaze direction for each image frame may include obtaining a first approximate circle based on the reflected light point information of each first reflected light point in the current image frame, based on the obtained first approximate circle being valid, determining the gaze direction for the current image frame based on the first approximate circle based on a second regression model, and based on the obtained first approximate circle being invalid, determining the gaze direction for the current image frame as the gaze direction for a previous image frame.

The determining of the gaze direction for each image frame based on the reflected light point information may include, based on a number of pairs of reflected light point determined in the current image frame being greater than a number of light sources, determining a pair of pseudo-reflected light points among the pairs of determined reflected light points, determining an eye center position based on the pair of pseudo-reflected light points, determining a corneal center position based on a pair of reflected light points other than the pair of pseudo-reflected light points among the pairs of reflected light points determined in the current image frame, and determining the gaze direction for the current image frame based on the eye center position and the corneal center position, wherein the pair of pseudo-reflected light points is determined based on event data obtained from a reflected light point signal reflected by a scleral sulcus surface.

The detecting of a pair of reflected light points corresponding to the light source in the current image frame may include determining a search region configured to detect a pair of reflected light points in the current image frame, and determining a pair of reflected light points corresponding to the light source based on a polarity of an event point determined based on the event data included in the search region.

The determining of the pair of reflected light points corresponding to the light source based on the polarity of event points determined based on the event data within the search region may include performing noise removal on the event points included in the search region, and determining a pair of reflected light points corresponding to the light source included in the search region from which the noise was removed based on polarity statistics results of the event points included in the search region from which the noise was removed.

The determining of the pair of reflected light points corresponding to the light source included in the search region from which the noise was removed, based on the polarity statistics results of the event points within the search region from which the noise was removed, may include, in the search region from which the noise was removed, for the event points having a first polarity, based on a number of event points having the first polarity included in the first region including the event points being greater than or equal to a fourth threshold and a number of event points having a second polarity included in a second region including the event points being greater than or equal to a fifth threshold, determining an average position of the event points having the first polarity within a third region including the event points as the position of the reflected light point of the first reflected light point among the reflected light point pairs, and deleting the event points from a fourth region including the position, wherein the first region is greater than or equal to the second region, and the position of the reflected light point of the first reflected light point corresponds to the pixel position of the first reflected light point in the current image frame.

The determining of the search region configured to detect a pair of reflected light points in the current image frame may include based on a pair of reflected light points being detected from a previous image frame of the current image frame, setting a region adjacent to the detected pair of reflected light points in the current image frame as the search region, and based on no pair of reflected light points being detected from the previous image frame of the current image frame, setting an entire region of the current image frame as the search region.

The determining of the search region configured to detect a pair of reflected light points in the current image frame may include, based on a first vector being greater than or equal to a sixth threshold, setting an entire region of the current image frame as the search region, based on the first vector being less than or equal to the sixth threshold, setting a designated region of the current image frame as the search region, wherein the first vector may correspond to a frame interval between the current image frame and an image frame in which the gaze direction is previously determined, and wherein the designated region may correspond to an approximate circle approximated based on the first reflected light point when previously detecting the gaze direction.

The detecting of a pair of reflected light points corresponding to the light source among the current image frame my include, based on a number of pairs of reflected light points determined in the current image frame being greater than the number of light sources, determining a pair of pseudo-reflected light points among the determined pairs of reflected light points, removing the pairs of pseudo-reflected light points, and determining the pairs of pseudo-reflected light points based on event data obtained from reflected light point signals reflected by the scleral sulcus surface.

The determining of a pair of pseudo-reflected light points among the determined pairs of reflected light points may include obtaining a first approximate circle by performing a circle approximation operation based on the reflected light point information of the first reflected light point among each pair of reflected light points of the current image frame, determining a first distance between the first reflected light point of each pair of reflected light points of the current image frame and the first approximate circle, and determining a pair of reflected light points corresponding to the first reflected light point having a first distance greater than a seventh threshold as the pair of pseudo-reflected light points.

According to another aspect of one or more embodiments, there is provided an interaction method including determining a gaze direction based on a method including obtaining a plurality of image frames by performing decoding based on data acquired by an event camera, determining reflected light point information for each image frame among the plurality of image frames, and determining the gaze direction for each image frame among the plurality of image frames based on the reflected light point information, wherein each image frame among the plurality of image frames includes event data obtained based on a reflected light point signal captured by the event camera, the reflected light point signal being light that is emitted from a light source and is reflected by a corneal surface, wherein the reflected light point information includes at least one of a reflected light point position and numbers of reflected light points corresponding to a pair of reflected light points obtained based on the event data, and performing an action for an object corresponding to the gaze direction based on receiving a user input.

The user input may include at least one of a click input or a touch input on a smart ring, a voice input, a gesture input, and an eye blink input.

According to still another aspect of one or more embodiments, there is provided an electronic device including at least one processor, at least one memory configured to store computer-executable instructions, wherein, when the computer-executable instructions are executed by the at least one processor, the at least one processor is configured to perform a method including obtaining a plurality of image frames by performing decoding based on data acquired by an event camera, determining reflected light point information for each image frame among the plurality of image frames, and determining the gaze direction for each image frame among the plurality of image frames based on the reflected light point information, wherein each image frame among the plurality of image frames includes event data obtained based on a reflected light point signal captured by the event camera, the reflected light point signal being light that is emitted from a light source and is reflected by a corneal surface, wherein the reflected light point information includes at least one of a reflected light point position and numbers of reflected light points corresponding to a pair of reflected light points obtained based on the event data, and performing an action for an object corresponding to the gaze direction based on receiving a user input.

### BRIEF DESCRIPTION OF DRAWINGS

The above and other aspects, features, and advantages of one or more embodiments will be more apparent from the following description taken in conjunction with the accompanying drawings, in which:

FIG. 1 is a flowchart illustrating a method of determining a gaze direction according to one or more embodiments;

FIG. 2A is a diagram illustrating an example when an event camera projects an event within a fixed time interval onto one image;

FIG. 2B is a diagram illustrating an example when one packet is decoded into four image frames;

FIG. 3 is a flowchart illustrating a process of obtaining an image frame from an event camera;

FIG. 4A is a diagram illustrating a method of arranging an event camera and a light source;

FIG. 4B is a diagram illustrating an operating principle of an event camera;

FIG. 4C is a diagram illustrating a process of an event camera to decode an image frame according to one or more embodiments;

FIG. 5 is a flowchart illustrating a process of determining reflected light point information for each image frame among a plurality of image frames according to one or more embodiments;

FIG. 6 is a diagram illustrating a process of determining a first frame of a set of image frames belonging to a same cycle according to one or more embodiments;

FIG. 7A is a flowchart illustrating a process of determining whether an image frame satisfying a requirement exists among the first frame and the second frame of the image frame set belonging to a same cycle according to one or more embodiments;

FIG. 7B illustrates an example of two previous frames of two cycles according to one or more embodiments;

FIG. 8 is a flowchart illustrating a process of detecting a pair of reflected light points corresponding to a light source in one frame according to one or more embodiments;

FIG. 9 is a flowchart illustrating a process of determining pair of pseudo-reflected light points according to one or more embodiments;

FIG. 10A illustrates an example of a first approximate circle determined through a circle approximation process according to one or more embodiments;

FIG. 10B is a diagram illustrating an example of a decoding frame according to one or more embodiments;

FIG. 11 is a flowchart illustrating a process of performing a decoding operation to obtain a reflected light point number of a first reflected light point of each pair of reflected light points of a decoding frame, according to one or more embodiments;

FIG. 12A is a flowchart illustrating a process of approximating a regression model according to one or more embodiments;

FIG. 12B is a diagram illustrating a correspondence relationship between reflected light point information and a regression model according to one or more embodiments;

FIG. 13 is a flowchart illustrating a process of determining a gaze direction based on a regression model according to one or more embodiments;

FIG. 14A is a flowchart illustrating a process of determining a gaze direction according to one or more embodiments;

FIG. 14B is a diagram illustrating a process of determining a gaze direction according to one or more embodiments;

FIG. 15 is a flowchart illustrating a process of approximating a regression model according to one or more other embodiments;

FIG. 16 is a flowchart illustrating a process of determining a gaze direction based on a regression model according to one or more other embodiments;

FIG. 17 is a flowchart illustrating a process of determining a gaze direction according to one or more other embodiments;

FIG. 18A is a flowchart illustrating a process of determining a gaze direction according to one or more other embodiments;

FIG. 18B is a diagram illustrating a process of determining a gaze direction according to one or more embodiments;

FIG. 19 is a flowchart illustrating an interaction method according to one or more embodiments; and

FIG. 20 is a block diagram illustrating an electronic device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

In order for those skilled in the art to better understand the technical solution of the disclosure, hereinafter, the technical solutions of the embodiments of the disclosure will be clearly and completely described with reference to the drawings.

One thing to note here is that the terms “first”, “second”, etc. used in the specification, claims of the disclosure, and the aforementioned drawings are intended to distinguish similar objects and are not intended to describe a specific order or chronological order. The data used in this way may be interchangeable, where appropriate, so that the embodiments of the disclosure described in the text may be implemented in an order not illustrated or described in the text. The implementations described in the following embodiments do not represent all implementations consistent with the disclosure. On the contrary, they are merely examples of devices and methods consistent with some aspects of the disclosure, as described in the claims to be described below.

The term “number” used in the specification, claims, and drawings of the disclosure may denote a number or quantity.

What to describe here is that “at least one of several items” in the disclosure includes all three parallel situations of “any one of among the several items,” “any plural of among the several items,” and “all of the several items.” For example, the expression “including at least one of A and B” includes three parallel situations: (1) including A; (2) including B; and (3) including A and B.

In a gaze estimation method, a gaze is estimated by using a method in which multiple cameras are combined (for example, an infrared camera is combined with a dynamic vision sensor (DVS) camera) to estimate the gaze. An infrared camera detects the center of the pupil and an edge of the eyelid, updates the geometric information using the DVS camera, and then, approximates the pupil ellipse using a regression algorithm, and finally regresses a gaze direction using parameters of the approximated ellipse. However, in the gaze estimation method using multiple cameras, the complexity of the procedure and hardware cost increase, and because the infrared camera consumes relatively large power, the gaze estimation method also increases an overall power consumption of the system. Unlike the aforementioned gaze estimation method, in other gaze estimation methods, a gaze estimation is performed using only one camera (for example, a DVS camera), but the gaze estimation method is only used for DVS cameras based on a camera serial interface (CSI) and may not be used for DVS cameras based on other interfaces, so its scalability is relatively low. To solve this matter, embodiments are directed to a gaze estimation method for a CPI-based DVS camera, which determines a gaze direction through data acquired by a CPI-based DVS camera, and for example, after converting a data stream acquired by a CSI-based DVS camera into a format of an image frame, the gaze direction may be determined through the method according to one or more embodiments.

Hereinafter, a gaze tracking method according to one or more embodiments will be described with reference to the drawings.

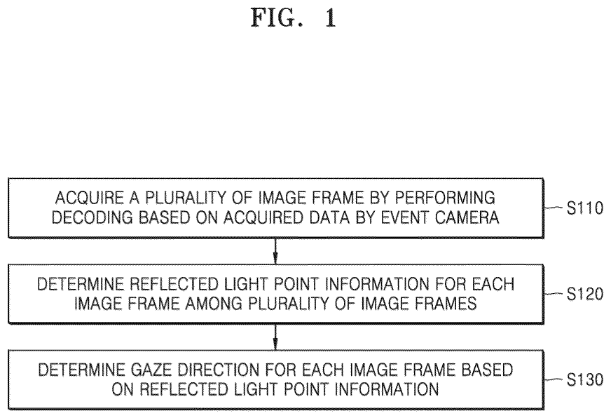

FIG. 1 is a flowchart illustrating a method of determining a gaze direction according to one or more embodiments.

Referring to FIG. 1, in operation S110, a plurality of image frames are acquired by performing decoding based on data acquired by an event camera. Each image frame includes event data acquired based on at least a reflected light point signal captured by the event camera, and the reflected light point signal is light emitted by a light source reflected through the corneal surface.

For example, the event camera is a special camera that generates a signal only for local brightness based on the biological retina principle. In the present disclosure, the event camera includes a CPI-based DVS camera. The CPI-based DVS camera is different from the CSI-based DVS camera, in that the CSI-based DVS camera measures changes in a scene and continuously outputs an event flow to the outside through the CSI. That is, the CPI-based DVS camera continuously outputs items (position (x, y), time staff (t), and event polarity(s)), wherein position (x, y) represents pixel coordinates where an event occurs.

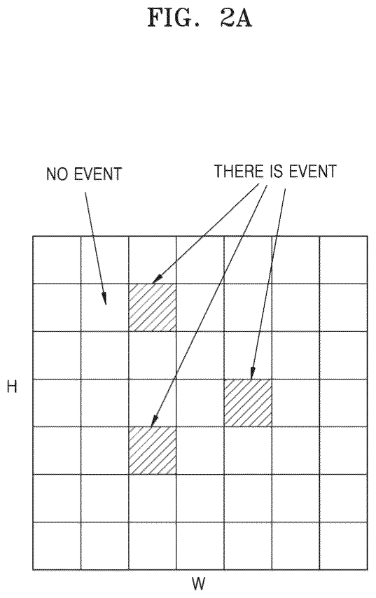

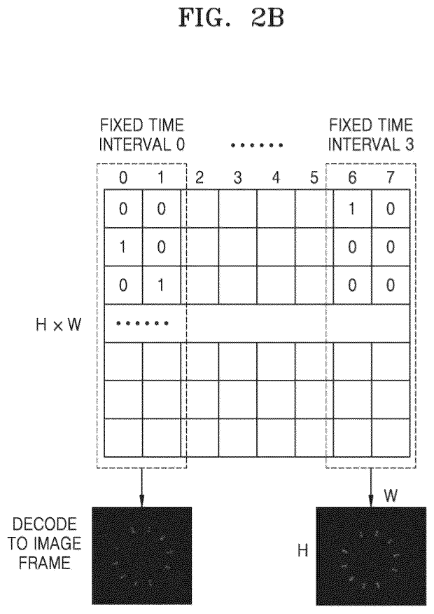

According to one or more embodiments, a CPI-based DVS camera may project an event within a fixed time interval onto a single image (as shown in FIG. 2A), and stores polarity information of the event in one byte at one pixel location. Because only 2 bits are required to indicate polarity information of one event, one byte at one pixel location may actually be used to indicate polarity information of four fixed time interval of the event. Correspondingly, according to one or more embodiments, four fixed time intervals are compressed into one packet. For example, the number of events in one packet may be at most W×H×4, where W and H each represent a width and a height of an image frame output by the CPI-based DVS camera. In the present disclosure, negative polarity of the event (polarity−1), no event, and positive polarity of the event (polarity+1) may be indicated by using binary values of “00,” “01,” and “10,” but embodiments are not limited thereto. Therefore, when determining a gaze direction, these packets (i.e., data acquired based on the event camera) may be decoded into four image frames and utilized as illustrated in FIG. 2B. In addition, events on each image frame have the same time stamp, and the time stamp of each image frame is the same as the time stamp of the event on the corresponding image frame. For example, each image frame actually includes event data acquired by the event camera based on a reflected light point signal in which light emitted from a light source is reflected through the corneal surface, and the event data includes at least polarity information about the event.

In the above example, for pixel points without events, information must be stored in the image frame (e.g., coordinates and a binary value corresponding thereto (e.g., “00”)), but in another CPI-based DVS camera, after distributing the same time stamp to events within a fixed time interval, information of pixel points where events are generated (i.e., events exist) within the fixed time interval may be output together as one image frame. For example, only information (e.g., coordinates and corresponding binary values) of pixel points where an event is generated (i.e., event exists) within a fixed time interval may be stored in one image frame.

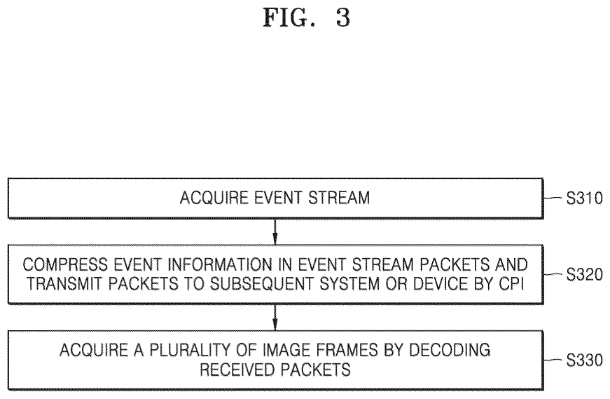

Therefore, according to one or more embodiments, a process of acquiring an image frame from a DVS camera is as illustrated in FIG. 3. First, in operation S310, an event stream is acquired with a CPI-based DVS camera. Thereafter, in operation S320, the event information in the acquired event stream is compressed into multiple packets by compressing information (i.e., event information) of four fixed time intervals into one packet. Afterwards, the compressed packet is transmitted to a subsequent system or device by CPI. Thereafter, in operation S330, the system or device decodes the data (i.e., packets) received and acquires multiple image frames.

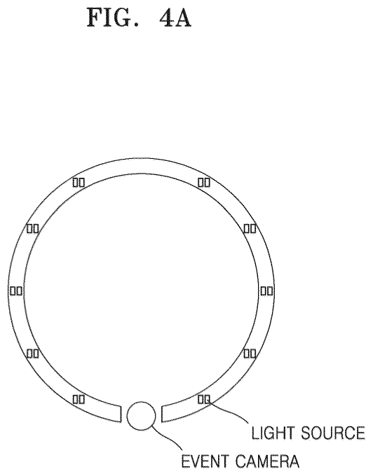

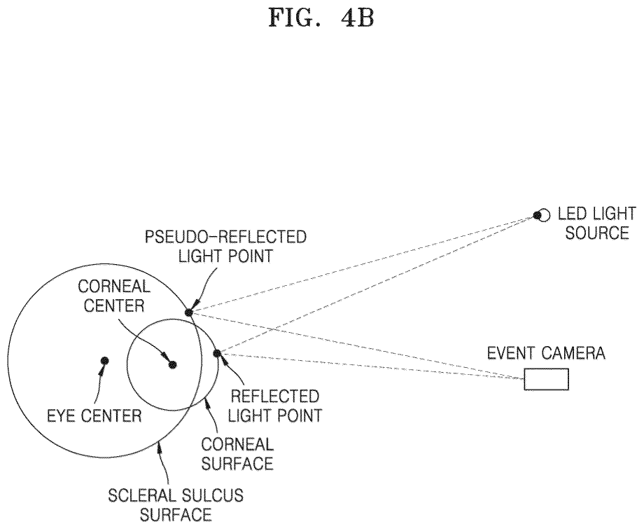

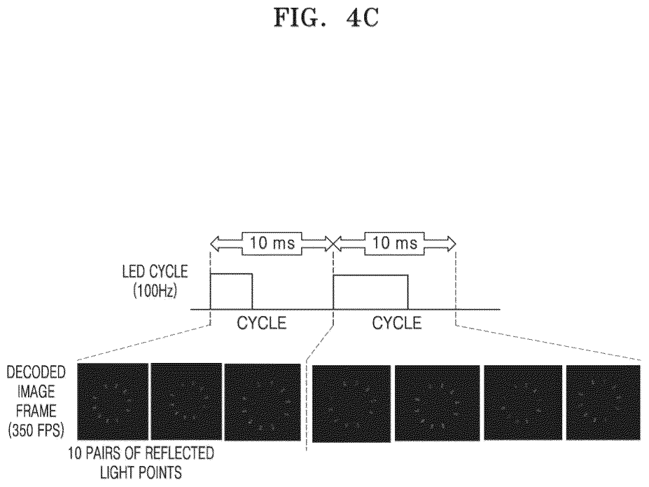

FIG. 4A illustrates an arrangement of a CPI-based DVS camera and a light source. The light source is 10 pairs of LED light sources, and the 10 pairs of light sources are arranged along a circle, and each pair of LED light sources includes an LED-primary light source and an LED-secondary light source that are close to each other. For example, the LED light source located in an inner circle may be called an LED-primary light source, and the LED light source located in an outer circle may be called an LED-secondary light source. The states of the LED-primary light source and the LED-secondary light source are opposite to each other. For example, the LED-primary light source and the LED-secondary light source may be alternately blinked. When the LED-primary light source and the LED-secondary light source alternately blink, as illustrated in FIG. 4B, the CPI-based DVS camera may capture a reflected light point signal that the light emitted from the LED light source is reflected by the corneal surface or the scleral sulcus surface, thereby acquiring event data. A point on the corneal surface (including the vicinity of an edge of the corneal surface) that reflects light emitted by the LED light source may be referred to as a “reflected light point” on the corneal surface. An image point corresponding to a “reflected light point” on the corneal surface formed on the image frame may be referred to as a “reflected light point” or a “reflected light point image point” on the image frame. A point on the corneal surface that reflects light emitted by the LED light source may be referred to as a “pseudo-reflected light point” on the scleral sulcus surface. An image point corresponding to a “pseudo-reflected light point” on the scleral sulcus surface formed on the image frame may be referred to as a “pseudo-reflected light point” or a “pseudo-reflected light point image point” on the image frame. According to one or more embodiments, when referring to a “reflected light point,” unless otherwise specifically described (e.g., a “reflected light point” on a corneal surface or a “pseudo-reflected light point” on a scleral sulcus surface), what is referred to is a “reflected light point image point” on an image frame, and when referring to a “pseudo-reflected light,” what is referred to is a “pseudo-reflected light point image point” on an image frame. FIG. 4C illustrates an image frame acquired by using a CPI-based DVS camera with a specific frequency LED light source and a corresponding frequency. In the present disclosure, the LED light source is turned ON and OFF in a periodic pattern. Within one LED cycle (referred to simply as a “cycle” in the text), the ON and OFF states may be changed once every ⅓ cycle or once every ⅔ cycle. In the non-limiting example of FIG. 4C, the LED light source is 100 Hz and the CPI-based DVS camera is 350 FPS. That is, one LED cycle (i.e., one cycle) is 10 ms, and each LED cycle includes an average of 3.5 image frames. For example, some LED cycles may include 3 image frames, and some other LED cycles may include 4 image frames. In each image frame, red and green represent events (also called “event points”) with positive polarity (+1) and negative polarity (−1), respectively. In other words, each decoding image frame includes event information with a time interval of less than 1/350 seconds.

In operation S120, for each image frame among the plurality of image frames, reflected light point information is determined, and the reflected light point information includes position of reflected light point related to a pair of reflected light points determined based on event data and/or reflected light point numbers.

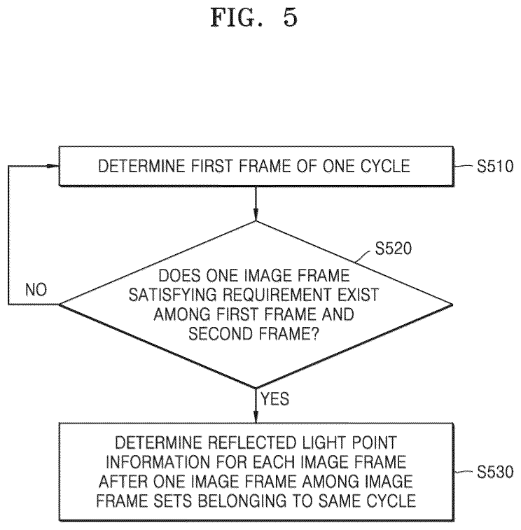

For example, as illustrated in FIG. 5, in operation S510, a first frame of a set of image frames belonging to the same cycle is determined based on time information related to the plurality of image frames. Operation S510 may include an operation of determining the next image frame as the first frame of the set of image frames if the time information of the current image frame is greater than the time information of the next image frame, or if the time interval between the current image frame and the next image frame is greater than a third threshold value T3. In the following description, for the convenience of understanding, an example in which the time information is a time stamp is described as an example, but embodiments are not limited thereto, and the time information may exist in other forms.

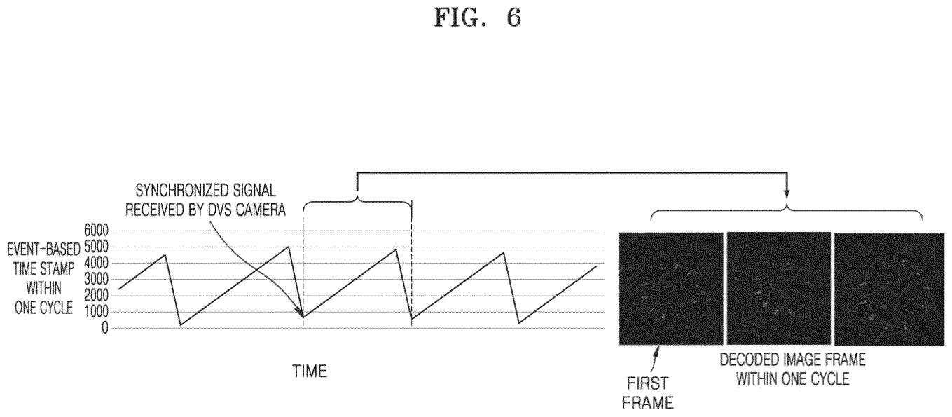

As illustrated in FIG. 6, according to one or more embodiments, a controller of an LED light source sends a synchronization signal to a CPI-based DVS camera at T fixed time intervals, and then the CPI-based DVS camera rearranges time stamps of the image frames so that the time stamp of the next image frame is less than the time stamp of the current image frame based on the synchronization signal. For example, T is a length of the LED cycle. Therefore, if it is determined that the time stamp of the current image frame among the decoding multiple image frames is greater than the time stamp of the next image frame, it may be determined that the next image frame belongs to a first frame of the image frame set (which may include multiple image frames) of the next cycle. In one or more other embodiments, the CPI-based DVS camera may convert the time stamp of the image frame set belonging to each cycle. For example, in the example shown in FIG. 4C (i.e., the LED light source is 100 Hz and the CPI-based DVS camera is 350 FPS), the time stamps of the four image frames of the current cycle are set to 0, 3, 6, and 9, respectively, and the time stamps of the three image frames of the next cycle are set to 1, 4, and 7, respectively, so that the time stamp of the last image frame of the current cycle becomes greater than the time stamp of the first image frame of the subsequent cycle. Therefore, if it is determined that the time stamp of the current image frame is greater than the time stamp of the next image frame among the decoding plurality of image frames, the next image frame may be determined as the first frame of the image frame set belonging to the next cycle.

In one or more other embodiments, the controller of the LED light source sends a synchronization signal to the CPI-based DVS camera at T fixed time intervals, and then the CPI-based DVS camera may increase the first time stamp of the current image frame by one preset value based on the synchronization signal so that the time interval between the time stamp of the current image frame and the time stamp of the next image frame is greater than or equal to the third threshold. Here, T is a length of the LED cycle. Accordingly, if it is determined that the time interval between the time stamp of the current image frame and the time stamp of the next image frame is greater than or equal to the third threshold among the decoded plurality of image frames, the next image frame may be determined as the first frame of the image frame set belonging to the next cycle.

Through the method described above, a first frame of the image frame set included in the same cycle may be determined.

In operation S520, it is sequentially determined whether one image frame among the first frame and the second frame of the image frame set included in the same cycle that satisfies the requirement.

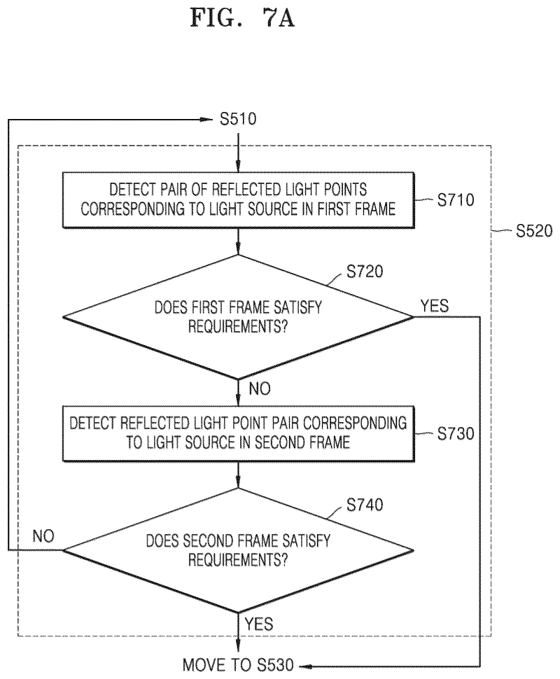

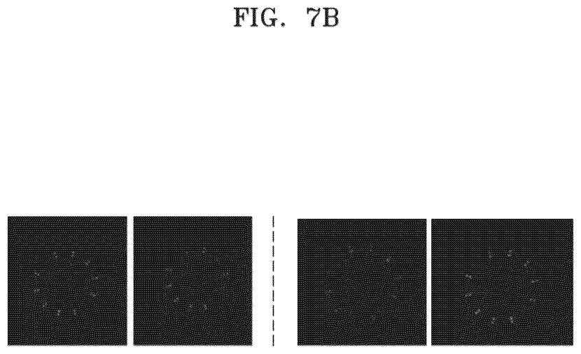

As illustrated in FIG. 7A, in operation S710, a pair of reflected light points corresponding to the light source is detected in the first frame.

In operation S720, it is determined whether the first frame satisfies the requirement.

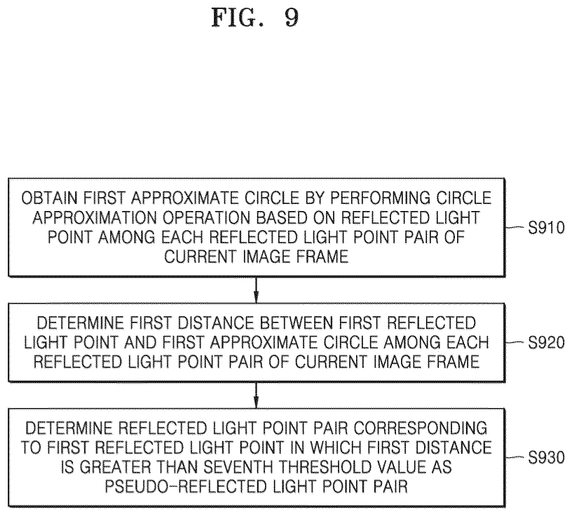

For example, it is determined whether a first approximate circle approximating for the reflected light points of the first frame is valid. Here, the process of approximating the first approximate circle for the reflected light points of the first frame will be described in detail with reference to operation S910 of FIG. 9 below. According to one or more embodiments, if a radius of the first approximate circle is located within the first section, the first approximate circle is valid. On the other hand, if the radius of the first approximate circle is not located within the first section, the first approximate circle is invalid (i.e., not valid). Here, the first section may be a section established based on experience, and may be, for example, a range of [60, 80] (unit: pixels), but is not limited thereto.

If it is determined that the first approximate circle approximated to the pair of reflected light points of the first frame is valid, it is determined whether the number of a pair of reflected light points of the first frame is greater than or equal to the first threshold value T1. Here, the pair of reflected light points of the first frame for comparison with the first threshold value T1 include initialization points (also referred to as first-type reflected light point) and/or semi-initialization points (also referred to as second-type reflected light point) preserved in the previous cycle (which will be described in detail later). In addition, the pair of reflected light points of the first frame for comparison with the first threshold value T1 may include a new pair of reflected light points newly detected in the first frame in operation S710 (a pair of reflected light points after a pair of pseudo-reflected light points is excluded). If the number of the pair of reflected light points of the first frame is greater than or equal to the first threshold value T1, it may be determined that the first frame satisfies the requirement. For example, if the number of the pair of reflected light points of the first frame is greater than or equal to the first threshold value T1, it is determined that the first frame is one image frame that satisfies the requirement in the image frame set, and operation S530, which will be described later, is performed.

Although the first approximate circle approximating the pair of reflected light points of the first frame is valid, if it is determined that the number of the pair of reflected light points of the first frame is less than the first threshold value T1 or the first approximate circle approximating the pair of reflected light points of the first frame is invalid, it may be determined that the first frame does not satisfy the requirement. In this case, the process moves to operation S730, and detects a pair of reflected light points corresponding to the light source from the second frame of the image frame set.

In operation S740, it is determined whether the second frame satisfies the requirement.

For example, it is determined whether the first approximate circle for the reflected light points of the second frame is valid.

If it is determined that the first approximate circle for the pair of reflected light points of the second frame is valid, it is determined whether the number of a pair of reflected light points of the second frame is greater than or equal to the second threshold value T2. If the number of the pair of reflected light points of the second frame is greater than or equal to the second threshold value T2, it is determined that the second frame satisfies the requirement, that is, the second frame is determined to be one image frame in the image frame set that satisfies the requirement, and operation S530 described below is performed.

If it is determined that the first approximate circle for the pair of reflected light points of the second frame is valid, but the number of the pair of reflected light points of the second frame is less than the second threshold value T2, or if it is determined that the first approximate circle for the pair of reflected light points of the second frame is invalid, it is determined that the second frame does not satisfy the requirement.

If it is determined that the second frame does not satisfy the requirement, returns to operation S510, determines the first frame of an image frame set belonging to the next cycle, and performs operation S520, i.e., operations S710 to S740 in a similar manner. FIG. 7B illustrates an example of two frames in the first half of two cycles. In the case on the left, the first frame satisfies the requirement (i.e., the first approximate circle for the pair of reflected light points of the first frame is valid, and the number of the pair of reflected light points of the first frame is greater than or equal to the first threshold value T1). In the case on the right, the first frame does not satisfy the requirement (i.e., although the first approximate circle approximating the pair of reflected light points of the first frame is valid, the number of the pair of reflected light points of the first frame is less than the first threshold value T1), but the second frame is one image frame that satisfies the requirement (i.e., the first approximate circle approximating the pair of reflected light points of the second frame is valid, and the number of the pair of reflected light points of the second frame is greater than or equal to the second threshold value T2).

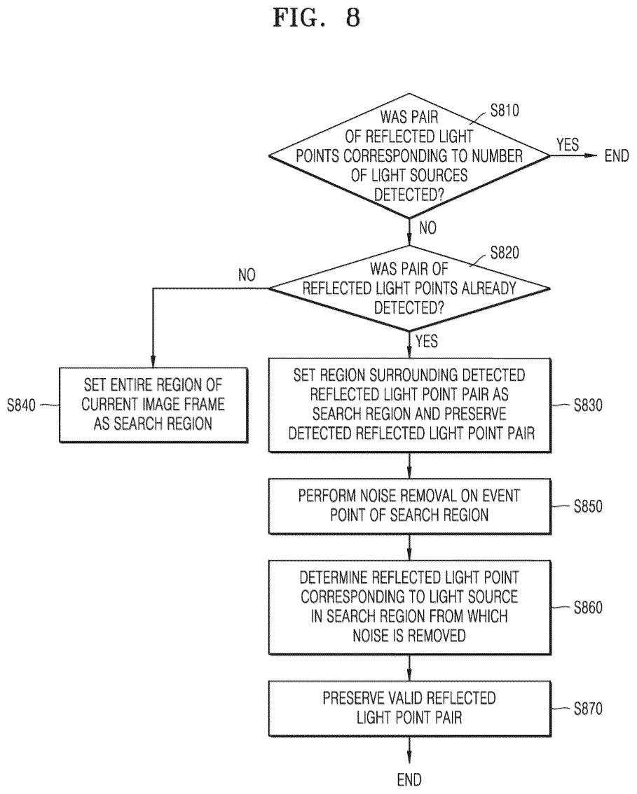

Hereinafter, with reference to FIG. 8, a process of detecting a reflected light point corresponding to the light source in a frame will be described in detail.

With reference to FIG. 8, in operation S810, it is determined whether the pair of reflected light points corresponding to the number of light sources has already been detected in a previous image frame of the current image frame. For example, assuming that the light source is K pairs of LED light sources, and thus, maximum K valid pair of reflected light points may be detected in one image frame, if there are already K preserved pair of reflected light points in the current image frame (i.e., K preserved initialization points and/or semi-initialization points from the previous image frame), the process of detecting the pair of reflected light points corresponding to the light source may be terminated in the current image frame. If there are no K preserved pair of reflected light points in the current image frame, the pair of reflected light points corresponding to the light source must be detected (or determined) in the current image frame. At this time, the operation of determining the pair of reflected light points corresponding to the light source in the current image frame may include determining a search region used for detecting reflected light points in the current image frame, and determining the pair of reflected light points corresponding to the light source based on the polarity of the event point determined based on the event data within the search region.

For example, in operation S820, it is determined whether a pair of reflected light points has already been detected in a previous image frame of the current image frame.

If some pairs of reflected light points have already been detected from a previous image frame of the current image frame (i.e., some initialization points and/or semi-initialization points are preserved in the previous image frame), the process moves to operation S830, and a region adjacent to and surrounding the detected pair of reflected light points in the current image frame is set as a search region, and the detected pair of reflected light points is preserved. For example, the search region is determined based on an approximate circle derived using the reflected light of the previous image frame. For example, an annular region or a circular region covering the approximate circle is determined as the search region.

For example, if no pair of reflected light points is detected from the previous image frame of the current image frame (i.e., no initialization point and/or semi-initialization point is preserved in the previous image frame), the process moves to operation S840, and the entire region of the current image frame is set as a search region. For example, the operation of determining the search region used for detecting reflected light points in the current image frame may include, if a pair of reflected light points is already detected in the previous image frame of the current image frame, an operation of setting a region adjacent to and surrounding the detected pair of reflected light points in the current image frame as the search region, and if no pair of reflected light points is detected in the previous image frame of the current image frame, an operation of setting the entire region of the current image frame as the search region.

After determining the search region, a reflected light point corresponding to the light source is determined based on the polarity of the event point of the search region.

For example, in operation S850, noise removal is performed on the event point of the search region. For example, if the number of event points detected within the region including one event point is less than a threshold value, the event point is considered as noise and is deleted.

In operation S860, the reflected light point corresponding to the light source is determined within the search region from which the noise has been removed based on the polarity statistics result of the event point within the search region from which the noise has been removed. For example, the operation S860 may include for event points having a first polarity in the search region from which noise has been removed, an operation of determining an average position of event points having the first polarity in a third region including the event points as a reflected light point position of the first reflected light point among the first pair of reflected light points and removing event points in a fourth region including the event points if the number of event points having the first polarity within the first region including the event point is greater than or equal to the fourth threshold T4 and the number of event points having the second polarity within the second region including the event point is greater than or equal to the fifth threshold T5. Here, the size of the first region is less than or equal to the size of the second region, and the reflected light point position of the first reflected light point indicates the pixel position of the first reflected light point in the current image frame.

For example, all event points in the search region from which noise has been removed may be searched, and for the current event point having the first polarity (e.g., +1), if the number of event points having the first polarity in the first region (e.g., 7×7 pixel region) including the current image frame or the current event point of the search region is greater than the fourth threshold T4, it may be determined whether the number of event points having the second polarity (e.g., −1) in the second region (e.g., 15×15 pixel region) including the current event in the current image frame or the search region is greater than or equal to the fifth threshold T5. At this time, if the size of the first region is less than or equal to the size of the second region, and the number is greater than or equal to the fifth threshold T5, it may be confirmed that a new pair of reflected light points has been found in the current image frame. In this case, in the third region (e.g., a 9×9 pixel region) including the current event point, the average position of the event points having the first polarity may be determined as the reflected light point position of the first reflected light point among the new pair of reflected light points. In the present disclosure, the sizes of the first region and the third region may be the same or different, but the present embodiment does not specifically limit the size, and an average position of the event points having the second polarity in another region (e.g., the second region) including the current event point may also be determined as a reflected light point position of the second reflected light point of the new pair of reflected light points. In addition, each pair of reflected light points includes two reflected light points, and for the convenience of explanation, the reflected light point located in the inner circle may be referred to as the first reflected light point in the text, but the present disclosure does not specifically define this, and the reflected light point located in the outer circle may also be referred to as the first reflected light point. In addition, after determining a new pair of reflected light points, by removing all event points within the fourth region among the reflected light point locations of the first reflected light point including the pair of reflected light points, other pair of reflected light points may be found until all new pair of reflected light points within the search region are found. In addition, the present disclosure does not specifically define the size of the fourth region, but it may be the same as or different from the first region, the second region, or the third region.

In the above description, all pairs of reflected light points within the current image frame may be determined through the above operations of FIG. 8, but the decoded image frame may further include event data obtained based on reflected light point signals captured by an event camera (i.e., a CPI-based DVS camera), where the reflected light point signals are light emitted from a light source and reflected by a scleral sulcus surface. For example, in every determined reflected light point, a pair of reflected light points determined based on such event data may exist, and such reflected light points may be referred to as a pair of pseudo-reflected light points, and the pair of pseudo-reflected light points is not determined based on event data obtained from a reflected light point signal reflected by the corneal surface, but is determined based on event data obtained from a reflected light point signal reflected by a scleral sulcus surface.

Therefore, the process illustrated in FIG. 8 may further include an operation S870 of removing a pair of pseudo-reflected light points, for example, leaving an effective pair of reflected light points. For example, the process of detecting a pair of reflected light points corresponding to the light source in the current image frame of FIG. 8 may further include an operation of determining a pair of pseudo-reflected light points among the determined reflected light points if the number of reflected light points determined in the current image frame is greater than the number of light sources, and removing the pair of pseudo-reflected light points.

Herein, embodiments are directed to determining a pair of pseudo-reflected light points based on a weighted circle approximation method. This will be described in detail below with reference to FIG. 9.

As illustrated in FIG. 9, in operation S910, a first approximate circle is obtained by performing a circle approximation operation based on reflected light point information of a first reflected light point among each pair of reflected light points of the current image frame.

For example, the first approximate circle is obtained by repeatedly performing an operation of determining a distance between a first reflected light point among each pair of reflected light points in the current image frame and a previously approximated approximate circle, an operation of determining a weight corresponding to each first reflected light point based on the distance, and an operation of obtaining an approximate circle by performing circle approximation for each first reflected light point based on the weights a specified number of times or until a difference between the results of the loss function that alternates before and after two times becomes less than or equal to the eighth threshold T8. At this time, the weight is inversely proportional to the distance. That is, the smaller the distance, the larger the weight. In one or more embodiments, the distance may be equal to a previously approximated radius of the approximate circle minus a distance from the first reflected light point to a previously approximated center of the approximate circle.

For example, the circle satisfies Equation 1 is as follows.

$${x}^{2} + {y}^{2} + ax + by + c = 0 \qquad [ Equation l ]$$

Here, (x, y) is the coordinate of the first reflected light point of the pair of reflected light points, and a, b, and c are three unknown coefficients.

Further, wi represents a weight for the first reflected light point (i), and assuming that a distance between the first reflected light point (i) and the previously approximated approximate circle is di, the weight wi corresponding to the first reflected light (i) may be determined based on Equation (2) below.

$${w}_{i} = exp ( - {d}_{i} ) \qquad [ Equation 2 ]$$

However, embodiments are not limited thereto, and the weight corresponding to the first reflected light point may be determined based on other positive monotonically decreasing functions.

In this case, the least squares loss function may be defined as Equation 3 below:

$$L = {\sum }_{i} {{w}_{i} ( {x}^{2} + {y}^{2} + a x + b y + c )}^{2} \qquad [ Equation 3 ]$$

If partial derivatives of L for each of a, b, and c are found, following Equations 4, 5, and 6 are obtained:

$$\frac{d L}{d a} = {\sum }_{i} 2 {w}_{i} ( {x}_{i}^{2} + {y}_{i}^{2} + a {x}_{i} + b {y}_{i} + c ) {x}_{i} = 0 \qquad [ Equation 4 ]$$

$$\frac{d L}{d b} = {\sum }_{i} 2 {w}_{i} ( {x}_{i}^{2} + {y}_{i}^{2} + a {x}_{i} + b {y}_{i} + c ) {y}_{i} = 0 \qquad [ Equation 5 ]$$

$$\frac{d L}{d c} = {\sum }_{i} 2 {w}_{i} ( {x}_{i}^{2} + {y}_{i}^{2} + a {x}_{i} + b {y}_{i} + c ) = 0 \qquad [ Equation 6 ]$$

By transforming the three equations mentioned above, the following set of Equations (7) may be obtained:

$$\{ \begin{matrix}\begin{matrix}{\sum }_{i} {w}_{i} ( {x}_{i}^{2} + {y}_{i}^{2} ) {x}_{i} + ( {\sum }_{i} {w}_{i} {x}_{i}^{2} ) a + ( {\sum }_{i} {w}_{i} {x}_{i} {y}_{i} ) b + \\ ( {\sum }_{i} {w}_{i} {x}_{i} ) c = 0 \\ {\sum }_{i} {w}_{i} ( {x}_{i}^{2} + {y}_{i}^{2} ) {y}_{i} + ( {\sum }_{i} {w}_{i} {x}_{i} {y}_{i} ) a + ( {\sum }_{i} {w}_{i} {y}_{i}^{2} ) b +\end{matrix} \\ ( {\sum }_{i} {w}_{i} {y}_{i} ) c = 0 \\ {\sum }_{i} {w}_{i} ( {x}_{i}^{2} + {y}_{i}^{2} ) + ( {\sum }_{i} {w}_{i} {x}_{i} ) a + ( {\sum }_{i} {w}_{i} {y}_{i} ) b + ( {\sum }_{i} {w}_{i} ) c = 0\end{matrix} \qquad [ Equation 7 ]$$

By solving the above three linear equations of a, b, and c, the values of the three unknown coefficients a, b, and c may be obtained based on Equation 8 below:

$$[ \begin{matrix}a \\ b \\ c\end{matrix} ] = {A}^{- 1} v \qquad [ Equation 8 ]$$

In Equation, 8, the following Equations 9 and 10 are satisfied:

$$A = [ \begin{matrix}{\sum }_{i} {w}_{i} {x}_{i}^{2} & {\sum }_{i} {w}_{i} {x}_{i} {y}_{i} & {\sum }_{i} {w}_{i} {x}_{i} \\ {\sum }_{i} {w}_{i} {x}_{i} {y}_{i} & {\sum }_{i} {w}_{i} {y}_{i}^{2} & {\sum }_{i} {w}_{i} {y}_{i} \\ {\sum }_{i} {w}_{i} {x}_{i} & {\sum }_{i} {w}_{i} {y}_{i} & {\sum }_{i} {w}_{i}\end{matrix} ] \qquad [ Equation 9 ]$$

$$v = [ \begin{matrix}- {\sum }_{i} {w}_{i} ( {x}_{i}^{2} + {y}_{i}^{2} ) {x}_{i} \\ - {\sum }_{i} {w}_{i} ( {x}_{i}^{2} + {y}_{i}^{2} ) {y}_{i} \\ - {\sum }_{i} {w}_{i} ( {x}_{i}^{2} + {y}_{i}^{2} )\end{matrix} ] \qquad [ Equation 10 ]$$

Correspondingly, based on equation (1), the specific expression of the circle x²+y²+ax+by +c=0 may be obtained. By transforming the specific expression of the circle, the following Equation 11 may be obtained:

$${( x + \frac{a}{2} )}^{2} + {( y + \frac{b}{2} )}^{2} + c - ( \frac{{a}^{2}}{4} + \frac{{b}^{2}}{4} ) = 0 \qquad [ Equation 11 ]$$

At this time, the center coordinates of the approximated circle are

$$( - \frac{a}{2} , - \frac{b}{2} ) ,$$

and the radius is

$$\sqrt{- c + \frac{{a}^{2}}{4} + \frac{{b}^{2}}{4}} .$$

In addition, according to one or more embodiments, in the first alternating operation, the weight wi corresponding to the first reflected light point (i) of each pair of reflected light points may be set to the same value. In one or more other embodiments, in the first alternating operation, the first approximate circle determined for the previous cycle may be determined as the previously approximated approximate circle, that is, the initial approximate circle of the current cycle, and in this case, the weight wi corresponding to each first reflected light point may be determined based on the distance di between the first reflected light point (i) of each reflected light point and the approximate circle.

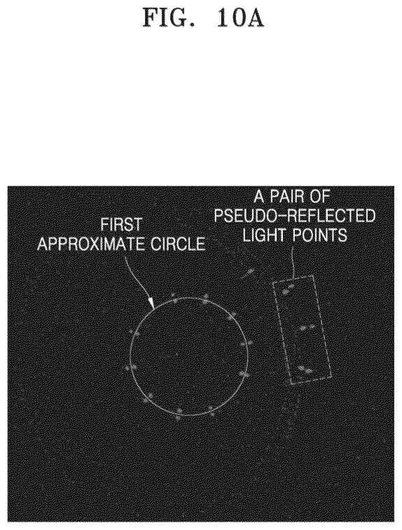

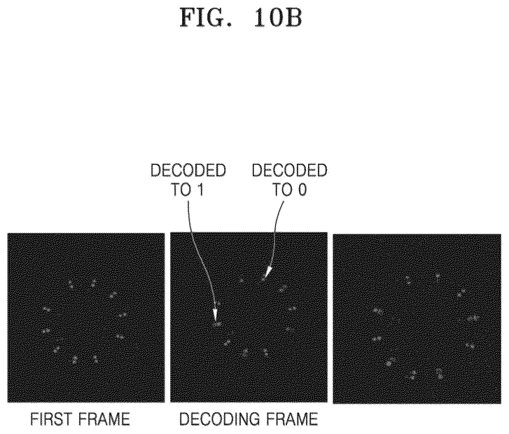

In the above, a process of performing one circle approximation by a specific equation has been described, and the first approximate circle may be determined by alternately performing the circle approximation process until a specified number of alternations or the difference between the loss function results of the two alternating operations before and after becomes less than or equal to the eighth threshold value T8. FIG. 10A illustrates an example of a first approximate circle finally obtained through the circle approximation process according to one or more embodiments, and the first approximate circle is as illustrated by the circle in FIG. 10A.

Next, in operation S920, in the current image frame, a first distance between the first reflected light point and the first approximate circle is determined for each pair of reflected light points.

For example, the first distance may be equal to the absolute value of the difference between the radius of the first approximate circle and the distance from the first reflected light point to the center of the first approximate circle.

In operation S930, a pair of reflected light points corresponding to the first reflected light point having the first distance is greater than the seventh threshold T7 is determined as a pair of pseudo-reflected light points. For example, if the first distance of one first reflected light point is greater than or equal to the seventh threshold T7, the pair of reflected light points corresponding to the first reflected light point may be determined as a pair of pseudo-reflected light points. As shown in FIG. 10A, several pairs of reflected light points located slightly far outside the circle are pairs of pseudo-reflected light points.

After determining the pair of pseudo-reflected light points among all determined pair of reflected light points, the pair of pseudo-reflected light points may be removed.

Referring again to FIG. 5, in operation S530, if there is one image frame satisfying the requirement among the first frame and the second frame, reflected light point information may be determined for each image frame after the one image frame among the image frame sets belonging to the same cycle, and the reflected light point information includes a reflected light point number and a reflected light point position.

In one or more embodiments, operation S530 may include, if a current image frame is selected as a decoding frame, performing a decoding operation based on the polarity of an event point associated with a first reflected light point of each pair of reflected light points in the decoding frame to obtain a reflected light point number of the first reflected light point of each pair of reflected light points in the decoding frame, and updating a reflected light point position of each first reflected light point of the decoding frame. The reflected light point position of the first reflected light point indicates a pixel position of the first reflected light point in the current image frame.

For example, it is determined whether each image frame after the one image frame in the image frame set belonging to the same cycle is selected as a decoding frame according to a time stamp order of the image frames, and after one image frame is selected as a decoding frame, the remaining image frames in the current cycle are no longer selected as decoding frames. For example, in one cycle, maximum one image frame is selected as a decoding frame. When determining whether the current image frame may be selected as a decoding frame, if at least one reflected light point having a polarity different from that of other reflected light points exists in all first reflected light points in the current image frame, the current image frame may be selected as a decoding frame. For example, if the first reflected light points located in an inner circle of the current image frame are clearly divided into two polarities, the current image frame is selected as a decoding frame. Accordingly, as illustrated in FIG. 10b, if the polarities of the first reflected light points located in the inner circle among the reflected light points of the first image frame are all the first polarity (e.g., +1), then in the decoding frame, if the polarity of one first reflected light point is still the first polarity, the first reflected light point is decoded as 1 in the cycle, and if the polarity of one reflected light point is the second polarity (e.g., −1), the first reflected light point is decoded as 0 in this cycle. However, embodiments are not limited thereto. In one or more other embodiments, if the polarities of the first reflected light points located in the inner circle among the reflected light points of the first image frame are all the first polarity (e.g., +1), then in the decoding frame, if the polarity of one first reflected light point is still the first polarity, the first reflected light point may be decoded as 0 in this cycle, and if the polarity of one first reflected light point is the second polarity (e.g., −1), the first reflected light point may be decoded as 1 in this cycle.

In addition, when selecting a decoding frame, if both the LED frequency and the CPI-based DVS frequency are fixed, the decoding frame may be determined among any two neighboring frames F0 and F1 within one cycle. For example, a position where the decoding frame appears in one cycle is fixed to any two neighboring image frames F_{K} and F_{K+1}. According to one or more embodiments, it may be determined whether the first image F_{K} among the two neighboring image frames F_{K} and F_{K+1} may be selected as a decoding frame. For example, if the polarities of the first reflected light points located in the inner circle among the reflected light points of the first image frame F_{K} are all the first polarity (for example, +1), the second image frame F_{K+1} (i.e., the next image frame) among the two neighboring image frames F_{K} and F_{K+1} may be selected as a decoding frame, and if not, the first image frame F_{K} among the two neighboring image frames F_{K} and F_{K+1} may be selected as a decoding frame. Here, the polarity of the first reflected light point is determined as the polarity with the largest number of polarities of event points within a designated region including the first reflected light point. For example, if the number of event points having the first polarity within a designated region including the first reflected light point is the largest, the first polarity is determined as the polarity of the first reflected light point. In addition, a decoding frame is typically selected from a frame between ⅓ and ⅔ cycles.

In addition, in the decoding frame, each first reflected light point may be classified into a first type reflected light point, a second type reflected light point, or a third type reflected light point. The first type reflected light point may also be referred to as an initialization point, the second type reflected light point may also be referred to as a semi-initialization point, and the third type reflected light point may also be referred to as an uninitialized point. The initialization point indicates a reflected light point in which the reflected light point number has already been determined. The semi-initialization point indicates a reflected light point in which at least some of a plurality of binary bits corresponding to the reflected light point number has already been determined but the reflected light point number has not yet been determined. The uninitialized point indicates a reflected light point in which none of the plurality of binary bits corresponding to the reflected light point number has been determined and the reflected light point number has not been determined yet.

According to one or more embodiments, the light source corresponds to the reflected light point, and the number of the light source is the number of the reflected light point (i.e., the reflected light point number), for example, 1, 2, 3, 4, . . . , 10. According to one or more embodiments, the reflected light point number may also be referred to as a reflected light point index, an index, a number, etc., but embodiments are not limited thereto. The number of each different light source may be encoded using a plurality of binary bits. For example, in the case of 10 light sources, the number of the light source may be encoded using 4 binary bits (e.g., a 4-digit binary code), and each cycle corresponds to one binary bit 0/1, and in this case, the number of the light source (i.e., the reflected light point number) may be decoded using 4 cycles. According to one or more embodiments, the numbers of the light sources may be encoded using an ambiguity-prevention encoding method, and as shown in Table 1 below, the encoding of each LED light source is the encoding of the LED-main light source among the LED light sources.

TABLE 1

| Symbol | Encoding | Encoding Ambiguity | Initial Ambiguity |
|---|---|---|---|
| Not Used | 0 0 0 1 | Ambiguity | Clear |
| Not Used | 0 0 1 0 | Ambiguity | Clear |
| Not Used | 0 1 0 0 | Ambiguity | Clear |
| LED-1 | 0 0 1 1 | Ambiguity | Clear |
| LED-2 | 1 1 0 0 | Ambiguity | Clear |
| LED-3 | 0 1 0 1 | Ambiguity | Ambiguity |
| LED-4 | 1 0 0 0 | Clear | Clear |
| LED-5 | 0 1 1 0 | Ambiguity | Clear |
| LED-6 | 1 1 1 1 | Clear | Ambiguity |
| LED-7 | 0 0 0 0 | Clear | Ambiguity |
| LED-8 | 1 0 1 0 | Ambiguity | Ambiguity |
| LED-9 | 0 1 1 1 | Clear | Clear |
| LED-10 | 1 0 0 1 | Ambiguity | Clear |
| Not Used | 1 0 1 1 | Ambiguity | Clear |
| Not Used | 1 1 0 1 | Ambiguity | Clear |
| Not Used | 1 1 1 0 | Ambiguity | Clear |

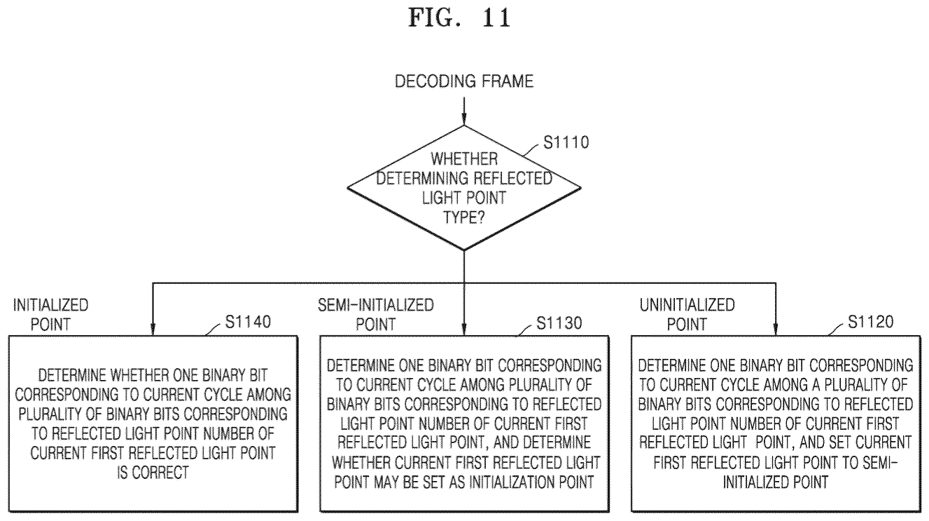

Hereinafter, referring to FIG. 11, a process of performing a decoding operation to obtain a reflected light point number of a first reflected light point among each pair of reflected light points of a decoding frame will be described in detail.

As illustrated in FIG. 11, in operation S1110, the reflected light point type of the current first reflected light point (i.e., the first reflected light point currently processed) is determined for the decoding frame. For example, it is determined whether the current first reflected light point is an uninitialized point, a semi-initialized point, or an initialized point.

In operation S1110, if the current first reflected light point is determined as an uninitialized point (i.e., a third type reflected light point), the process moves to operation S1120, and, based on the polarity of the event point related to the current first reflected light point, one binary bit corresponding to the current cycle is determined among a plurality of binary bits corresponding to the reflected light point number of the current first reflected light point, and the current first reflected light point is set to a semi-initialized point (i.e., a second type reflected light point). According to one or more embodiments, if a new pair of reflected light points is newly detected from an image frame, the first reflected light point of the newly detected reflected light pair is set as an uninitialized point.

For example, the operation of determining one binary bit corresponding to the current cycle among a plurality of binary bits corresponding to the reflected light point number of the current first reflected light point based on the polarity of the event point related to the current first reflected light point may include an operation of determining a first number of event points having the first polarity and a second number of event points having the second polarity within a fifth region including the current first reflected light point, and an operation of determining one binary bit corresponding to the current cycle among a plurality of binary bits corresponding to the reflected light point number of the current first reflected light point based on the polarity corresponding to the maximum value of the first number and the second number and the correspondence relationship between the first polarity and the second polarity and 0 and 1.

For example, based on the polarity statistics results of event points in the fifth region including the current first reflected light point, if it is determined that the first number of event points having a first polarity (e.g., +1) is greater than or equal to the second number of event points having the second polarity (e.g., −1) and the first number is greater than the ninth threshold T9, the polarity of the current first reflected light point is determined as the first polarity (e.g., +1), and if the first polarity corresponds to 1, one binary bit corresponding to the current cycle among the four binary bits corresponding to the reflected light point number of the current first reflected light point is determined as 1. Based on the polarity statistics results of the event points in the fifth region including the current first reflected light point, if it is determined that the first number of event points having a first polarity (e.g., +1) is less than the second number of event points having a second polarity (e.g., −1) and the second number is greater than a ninth threshold T9, the polarity of the current first reflected light point is determined as the second polarity (e.g., −1), and if the second polarity corresponds to 0, one binary bit corresponding to the current cycle among the four binary bits corresponding to the reflected light point number of the current first reflected light point is determined as 0. At this time, because among the plurality of binary bits corresponding to the reflected light point number of the current first reflected light point, one binary bit has already been determined but the reflected light point number has not yet been determined, the current first reflected light point may be set as a semi-initialization point.

In operation S1110, if the current first reflected light point is determined to be a semi-initialization point (i.e., a second type reflected light point), the process moves to operation S1130, and based on the polarity of the event point related to the current first reflected light point, one binary bit corresponding to the current cycle among the plurality of binary bits corresponding to the reflected light point number of the current first reflected light point is determined, and it is determined whether the current first reflected light point may be set as an initialization point (i.e., a first type reflected light point).

Here, the process of determining one binary bit corresponding to the current cycle among the plurality of binary bits corresponding to the reflected light point number of the current first reflected light point in operation S1130 is the same as the process of determining one binary bit corresponding to the current cycle among the plurality of binary bits corresponding to the reflected light point number of the current first reflected light point described in operation S1120, so a duplicate description is omitted.

In addition, the operation of determining whether the current first reflected light point may be set as an initialization point may include if the plurality of binary bits corresponding to the reflected light point number of the current first reflected light point have already been determined, an operation of determining the reflected light point number of the current first reflected light point based on the plurality of binary bits corresponding to the reflected light point number of the current first reflected light point and the encoding rule of the light source defined in advance. If the reflected light point number of the current first reflected light point is determined, the current first reflected light point is set as an initialization point, and if the reflected light point number of the current first reflected light point is not determined, the current first reflected light point is set as an uninitialized point.

For example, if a plurality of binary bits corresponding to the reflected light point number of the current first reflected light point have already been determined, a predefined light source encoding rule (e.g., Table 1) may be looked up through the binary bits, and if there is a reflected light point number (e.g., 4 binary bits 1000) corresponding to the plurality of binary bits corresponding to the reflected light point number of the current first reflected light point among the predefined light source encoding rule, the reflected light point number of the current first reflected light point (e.g., 4) may be determined. At this time, because the reflected light point number of the current first reflected light point has already been determined, the current first reflected light point may be set as an initialization point. In addition, when a plurality of binary bits corresponding to the reflected light point number of the current first reflected light point have already been determined, if there is no reflected light point number corresponding to the plurality of binary bits corresponding to the reflected light point number of the current first reflected light point in the predefined light source encoding rule (Table 1), the current first reflected light point is set as an uninitialized point.

In operation S1110, if the current first reflected light point is determined to be an initialization point (i.e., a first type reflected light point), the process moves to operation S1140, and based on the polarity of the event point related to the current first reflected light point, it may be determine whether one binary bit corresponding to the current cycle among the plurality of binary bits corresponding to the reflected light point number of the current first reflected light point is correct. If the one binary bit is not correct, the current first reflected light point is set as an uninitialized point. In addition, if the one binary bit is correct, the current first reflected light point is set as an initialization point as it is. In addition, after the current cycle ends, only the initialization point and the semi-initialization point are left, and these are used for subsequent cycle processing.

For example, the operation of determining whether one binary bit corresponding to the current cycle among the plurality of binary bits corresponding to the reflected light point number of the current first reflected light point is correct based on the polarity of the event point related to the current first reflected light point includes an operation of determining the number of event points having a polarity corresponding to the one binary bit within a sixth region including the current first reflected light point, and an operation of determining that the one binary bit is correct if the number is greater than a ninth threshold value T9 and determining that the one binary bit is incorrect if the number is less than or equal to the ninth threshold value T9. For example, if the first polarity (e.g., +1) corresponds to binary bit 1 and the second polarity (e.g., −1) corresponds to binary bit 0, and if one binary bit corresponding to the current cycle among the four binary bits corresponding to the reflected light point number of the current first reflected light point is 1, statistics are obtained for the first number of event points having the first polarity (e.g., +1) corresponding to the one binary bit within the sixth region including the current first reflected light point. If the first number is greater than the ninth threshold T9, it is determined that the one binary bit corresponding to the current cycle among the four binary bits corresponding to the reflected light point number of the current first reflected light point is correct. Also, if the first number is less than or equal to the ninth threshold T9, it is determined that the one binary bit is not correct. According to one or more embodiments, the fifth region and the second region may be the same or different, however, embodiments are not limited thereto.

In addition, after obtaining the reflected light point number of the first reflected light point among each pair of reflected light points of the decoded frame, the reflected light point position of each first reflected light point of the decoding frame must be updated. At this time, the reflected light point position of the first reflected light point indicates the pixel position of the first reflected light point in the current image frame. For example, if the polarity of the current first reflected light point is the first polarity (for example, +1) (i.e., a plurality of event points within the designated region including the current first reflected light point have the first polarity), an average value position of the event points having the first polarity within the third region including the event point may be determined as the reflected light point position of the current first reflected light point. If the polarity of the current first reflected light point is the second polarity (e.g., −1) (that is, multiple event points within the designated region including the current first reflected light point have the second polarity), an average position of the event points having the second polarity within the third region including the event point may be determined as the reflected light point position of the current first reflected light point.

By performing the decoding operation described above for four consecutive cycles according to the process described above, the reflected light point number of each first reflected light point may be determined. In addition, because there is no significant change in position at each first reflected light point compared to the first approximate circle determined in the previous image frame, according to one or more embodiments, the reflected light point number of each first reflected light point may be determined based on the relative position of each first reflected light point and the previously approximated first approximate circle. In addition, based on the relative positions of each first reflected light point and the previously approximated first approximate circle, after roughly determining the position of each first reflected light point in the current image frame, the exact position of each first reflected light point may be determined by searching a designated region including the roughly determined positions of each first reflected light point.

In addition, operation S530 may further include an operation of updating the reflected light point position of each first reflected light point of the current image frame if the current image frame is not selected as a decoding frame. Because the update process is the same as the process of updating the reflected light point position of each first reflected light point of the decoding image frame, the descriptions thereof will not be repeated.

Referring again to FIG. 1, in operation S130, a gaze direction of each image frame is determined based on the reflected light point information. The operation of determining the gaze direction of each image frame based on the reflected light point information includes, if the current image frame is selected as the decoding frame and a gaze tracking for the current image frame is successful, an operation of determining the gaze direction of the current image frame based on the reflected light point information of each first reflected light point in which reflected light point information has already been determined among the current image frame, and, if the current image frame is not selected as the decoding frame, an operation of determining the gaze direction of the current image frame based on the reflected light point information of each first reflected light point in which reflected light point information has already been determined among the current image frame.

For example, when determining the gaze direction of the current image frame, it is necessary to determine whether gaze tracking for the decoding frame is successful in the decoding frame, and if gaze tracking for the decoding frame is successful, the gaze direction is determined based on the reflected light point information of each first reflected light point among the decoding frames in which reflected light point information has already been determined. For example, the gaze direction is determined using the reflected light point information (i.e., the reflected light point number and the reflected light point position) of the initialization point of the decoding frame. If gaze tracking for the decoding frame fails, the operation of the present cycle is terminated. For example, the gaze direction of the image frame located behind the image decoding frame during the present cycle is no longer determined, and the operation for the image frame of the next cycle is performed.

According to one or more embodiments, if any one of the following conditions (1) to (3) is satisfied, it is determined that the gaze tracking for the current image frame is failed.

Under condition (1), the radius of the first approximate circle based on all the first reflected light points in the current image frame is not located within the first section.

Under condition (2), the number of initialization points in the current image frame is located within the second section.

Under condition (3), the number of the first reflected light points that are not located within the corresponding theoretical position region in the current image frame is greater than a tenth threshold T10.

As described above with reference to FIG. 7A, under condition (1), the first section may be an empirically installed section (for example, a range of [60, 80] (unit: pixels)), and if the radius of the first approximate circle is in a range of about 60 to about 80, the gaze tracking for the current image frame is considered successful, otherwise, the gaze tracking for the current image frame is considered failed.

Under condition (2), assuming the number of initialization points is N2, if c>N2>1, where c is a specified threshold (e.g., 5, but not limited thereto), then the gaze tracking for the current image frame is considered failed, otherwise, the gaze tracking for the current image frame is considered succeeded.

Under condition (3), for each first reflected light point, because the relative position with respect to the first approximate circle is usually fixed, for each first reflected light point, one relative position region (i.e., as one theoretical position region or ideal position region, for example, a relatively small region such as a 5×5 region) with respect to the center of the first approximate circle (i.e., an approximate circle based on all the first reflected light points of the current image frame) may be defined. In the current image frame, if at least one first reflected light point is not located in the relative position region defined (e.g., if one reflected light point is located outside the relative position region defined), statistics on the number of the at least one first reflected light point may be obtained (for example, statistics on the number of reflected light points that are not near the theoretical position of the reflected light point). The number is compared with the tenth threshold T10, and if the number is greater than the tenth threshold T10, it is considered that the gaze tracking for the current image frame is failed. If the number is less than or equal to the tenth threshold T10, it is considered that the gaze tracking for the current image frame is succeeded. In addition, although conditions (1), (2), and (3) are listed above, it is also possible to determine whether the gaze tracking for the current image frame is failed by determining only one of these conditions, and embodiments are not limited thereto.

With respect to an image frame that is not selected as a decoding frame, it is necessary to first determine whether at least one first reflected light point in which reflected light point information has already been determined exists in the corresponding image frame. This is because when determining the gaze direction, regression calculation must be performed using the reflected light point information (i.e., the reflected light point number and the reflected light point position). For example, the reflected light point number and the reflected light point position may be used to obtain regression when determining the gaze direction. If there is at least one first reflected light point for which reflected light point information has already been determined in the image frame, the gaze direction may be determined according to the same operation as the decoding frame.

In one or more embodiments, the gaze direction may be determined by a gaze estimation method based on reflected light point regression. According to one or more embodiments, a plurality of regression models, for example, nine regression models, Rᵢ, i=0 . . . 8 are defined. The nine regression models, after calculating (obtaining) at least one gaze direction (reflected light point information of each set including reflected light point information of at least one reflected light point) by inputting a set of reflected light point information as input, then determines the gaze direction of the current image frame based on the calculated (obtained) at least one gaze direction.

In the above method, first, the multiple regression models defined above should be approximated offline, and for the convenience of explanation, the nine regression models are described below as examples.

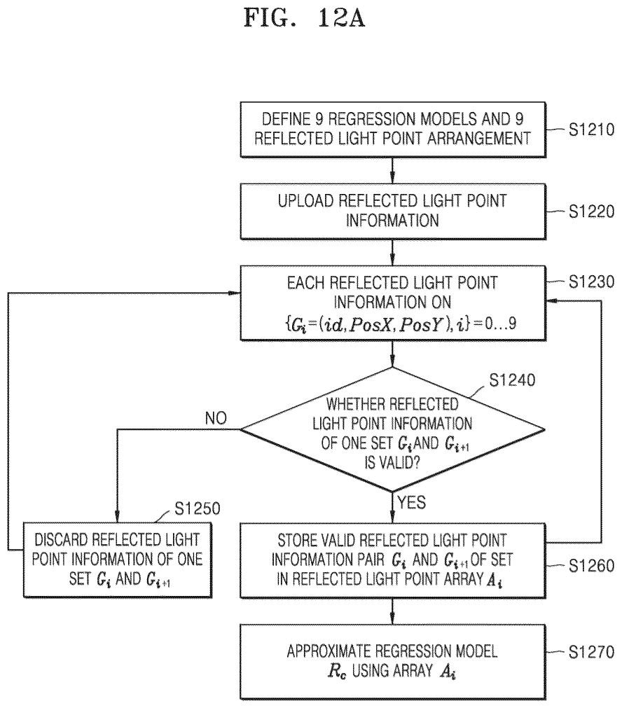

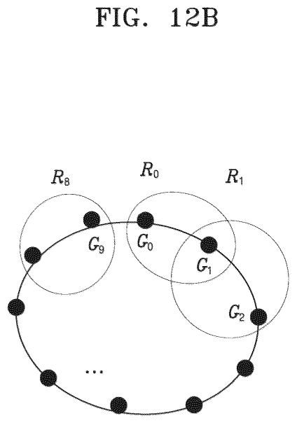

For example, as shown in FIG. 12A, the nine regression models are first defined in operation S1210 (Cambria Math, i=0 . . . 8) and a corresponding number of reflected light point arrays (Aᵢ, i=0 . . . 8) are defined. Although nine regression models and nine reflected light point arrays are described as examples, embodiments are not limited thereto. For example, the method of C₁₀^{N} may be used to select N reflected light points as one set of reflected light point information. Furthermore, a set of pieces of reflected light point information corresponding to each regression model is input or more or fewer regression models may be defined and a corresponding number of reflected light point arrays may be defined.

In operation S1220, the reflected light point information is uploaded. For example, the reflected light point information of each first reflected light point successfully determined in the current image frame is uploaded. It is assumed that the reflected light point information of 10 first reflected light points in the current image frame ({Gᵢ=(id, posX, posY)}, i=0 . . . 9 is successfully determined, where id represents the reflected light point number of the first reflected light point, and posX and posY represent the reflected light point position of the first reflected light point. In operations S1230 and S1240, the validity of one set of reflected light point information Gᵢ and Gᵢ₊₁ is determined for each reflected light point information Gᵢ. For each of Gᵢ and Gᵢ₊₁ (i≠9), if posX!=−1 and posY!=−1, the reflected light point information (Gᵢ and Gᵢ₊₁ of the set is determined to be valid and the process moves to operation S1260. Otherwise, the set of reflected light point information Gᵢ and Gᵢ₊₁ is determined to be invalid, and the process moves to operation S1250. In operation S1250, the invalid set of reflected light point information Gᵢ and Gᵢ₊₁ is discarded. In operation S1260, the valid reflected light point information pair Aᵢ and Gᵢ₊₁ of the set is stored in the reflected light point array Aᵢ, and then in step S1270, the corresponding regression model Rᵢ is approximated using the array Aᵢ. That is, the parameters of the corresponding regression model Rᵢ are approximated. FIG. 12B illustrates a correspondence between the reflected light point information and the regression model, and the correspondence may also be understood as the correspondence between the first reflected light point and the regression model. In FIG. 12B, the set of reflected light point information G₀ and G₁ corresponds to the regression model R₀, and the set of reflected light point information G₁ and G₂ corresponds to the regression model Rᵢ, and from this result, the set of reflected light point information G₈ and G₉ is inferred until the set of reflected light point information G₈ and G₉ corresponds to the regression model R₉.

In one or more embodiments, the gaze regression formula of the k^{th} regression model is defined by the following Equation 12:

$${α}_{k} = {p}_{k}^{T} {q}_{k} \qquad [ Equation 12 ]$$

At this time, αₖ is the line of sight obtained by the regression model, representing a vector of 2 rows and 1 column, pₖ is a projection matrix or regression matrix, which is a matrix of m rows and 2 columns, and qₖ is a vector of m rows and 1 column in which the reflected light point position (i.e., coordinate) of the first reflected light point used is expanded and transformed. Here, the expansion is a method of calculating the 1st, 2nd, and 3rd powers of the horizontal coordinate, respectively, that is, it may be a method of obtaining a higher-dimensional vector by variously transforming an original vector. By approximating the line of sight regression formula, parameters of each regression model may be finally obtained. Based on this method, the line of sight direction may be determined for the current image frame based on the reflected light point information of the first reflected light point in which reflected light point information has already been determined among the current frame images using the approximated regression model, which will be described in detail below.

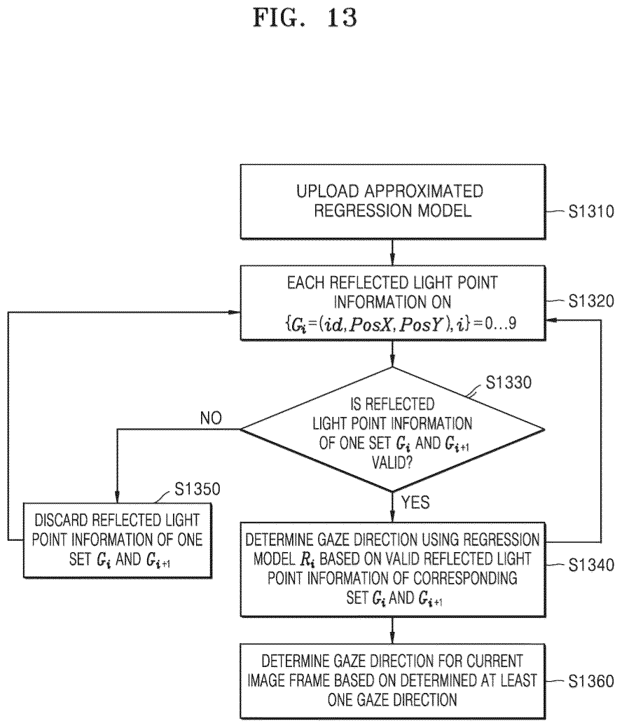

In one or more embodiments, the operation of determining a gaze direction for the current image frame based on reflected light point information of each of the first reflected light points, in which reflected light point information has already been determined, includes determining at least one set of valid reflected light point information from a plurality of first reflected light points in which reflected light point information has already been determined, where each set of valid reflected light point information includes valid reflected light point information of a first number of the first reflected light points, determining one gaze direction by using a corresponding first regression model based on each set of valid reflected light point information, and determining the gaze direction of the current image frame based on the determined at least one gaze direction. Hereinafter, referring to FIG. 13, the method of determining the gaze direction will be described in detail. For convenience of explanation, the regression models use the corresponding nine regression models shown in FIG. 12A and FIG. 12B and 10 LED light sources are used as light sources.

As shown in FIG. 13, in operation S1310, an approximate regression model is uploaded. For example, the parameters of the regression model are uploaded.

Afterwards, in operations S1320 and S1330, for each reflected light information Gᵢ, the validity of a set of reflected light point information Gᵢ and Gᵢ₊₁ is determined, and for each of Gᵢ and Gᵢ₊₁ (i≠9), if, posX!=−1 and posY!=−1, the reflected light point information Gᵢ and Gᵢ₊₁ of the set is determined to be a set of valid reflected light points Gᵢ and Gᵢ₊₁. In this way, at least one set of valid reflected light point information may be determined from a plurality of first reflected light points in which reflected light point information has already been determined among the current image frames, and each set of valid reflected light point information may include valid reflected light point information of the first number of first reflected light points. In FIG. 13, the number of the plurality of first reflected light points in which reflected light point information has already been determined among the current image frames is maximum 10, and the valid reflected light point information of each set includes the valid reflected light point information of two first reflected light points.

Whenever a valid set of valid reflected light point information Gᵢ and Gᵢ₊₁ is determined through operation S1330, the process moves to operation S1340. In operation S1340, based on the one set of valid reflected light point information Gᵢ and Gᵢ₊₁, a gaze direction may be determined (calculated) using a regression model Rᵢ. And, returning to operation S1320, the next set of reflected light point information may be determined continuously. In addition, if one set of reflected light point information Gᵢ and Gᵢ₊₁ is determined as invalid through operation S1330, the operation moves to operation S1350, discards the one set of reflected light point information Gᵢ and Gᵢ₊₁, and returns to operation S1320, and the next set of reflected light point information may be determined continuously.

In addition, if one gaze direction is already determined based on the valid reflected light point information of each set, operation S1360 may be performed to determine the gaze direction for the current image frame based on at least one of the determined gaze directions. For example, assuming that six gaze directions are determined, an average gaze direction of the six gaze directions may be determined as the gaze direction for the current image frame for the current frame.

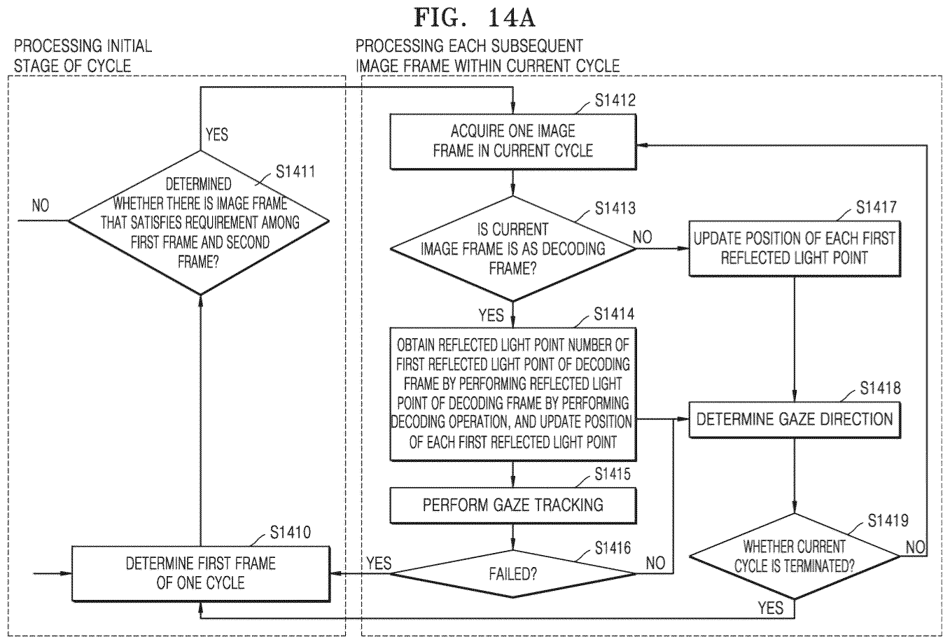

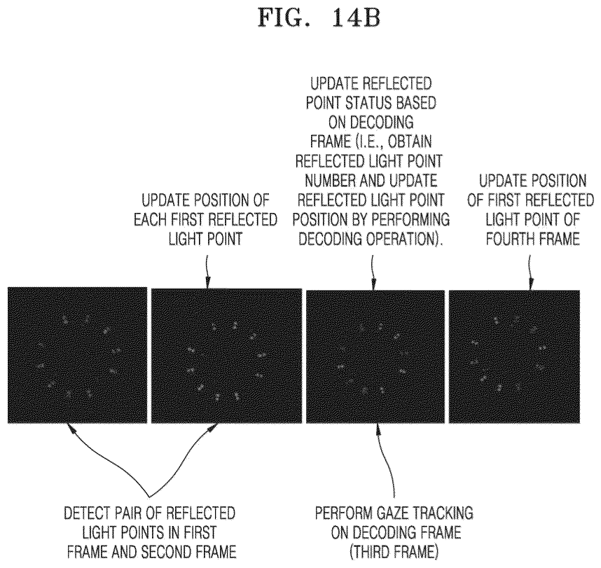

A method of determining a gaze direction based on a regression model by using the reflected light information including the reflected light point number and the reflected light point position after determining the reflected light point number of each reflected light point through the decoding frame has been described. In order to facilitate understanding the above method, the process will be described in its entirety with reference to FIGS. 14A and 14B below.

FIG. 14A is a flowchart illustrating a process of determining a gaze direction according to one or more embodiments.

As illustrated in FIG. 14A, in operation S1410, a first frame of one cycle is determined. Because this process may be described in the same way as the specific process of operation S510 above, the descriptions thereof will not be repeated.

Thereafter, in operation S1411, as illustrated in FIG. 14B, it is sequentially determined whether there is an image frame that satisfies the requirement among the first frame and the second frame of the current cycle. This process may be described in the same way as the specific process of operation S520 above, the descriptions thereof will not be repeated. According to one or more embodiments, operations S1410 and S1411 may be referred to as initialization operation processing for one cycle.

If it is determined that one of the first frame and the second frame of the current cycle satisfies the requirement, operation S1412 is performed to obtain one image frame of the current cycle. In the example of FIG. 14B, the first frame does not satisfy the requirement, but the second frame satisfies the requirement. Referring to operation S110 of FIG. 1, the process of obtaining a plurality of image frames by performing decoding based on data acquired by the event camera has been described, and if operation S1412 is performed after operation S1411, one image frame acquired in operation S1412 may be a frame located after one image frame that satisfies the requirement determined in operation S1411 among the image frame sets belonging to the current cycle.

In operation S1413, it is determined whether the acquired current image frame is selected as a decoding frame. When determining whether the current image frame may be selected as a decoding frame, if at least one reflected light point having a polarity different from the polarity of other reflected light points among all the first reflected light points in the current image frame exists, the current image frame may be selected as a decoding frame. For example, if the reflected light points located in an inner circle of the current image frame are clearly divided into two polarities, the current image frame is selected as a decoding frame. Because the process of determining whether the current image frame is selected as a decoding frame has already been described in detail with reference to operation S530, the descriptions thereof will not be repeated.

If the current image frame is selected as a decoding frame, operation S1414 is performed. For example, a decoding operation is performed to obtain a reflected light point number of the first reflected light point among each pair of reflected light points of the decoding frame, and the reflected light point position of each first reflected light point of the decoding frame is updated. At this time, the obtaining the reflected light point number and updating the reflected light point position may be referred to as a state of updating the reflected light point. The reflected light point position of the first reflected light point indicates the pixel position of the first reflected light point in the current image frame. In the example illustrated in FIG. 14B, because a third frame is selected as the decoding frame, the state of the reflected light point is updated for the third frame. Because the process of performing a decoding operation to obtain the reflected light point number of each first reflected light point of the decoding frame and updating the reflected light point position of the first reflected light point has been described in detail, the overlapping descriptions are omitted.

In operations S1415 and S1416, a detection of gaze tracking is performed and it is determined whether the gaze tracking is successful. For example, if any one of the conditions (1) to (3) below is satisfied, it is determined that the gaze tracking for the current image frame is failed.

Under condition (1), a radius of the first approximate circle approximated based on the reflected light point information of all the first reflected light points in the current image frame is not located within the first section.

Under condition (2), the number of initialization points in the current image frame is located within a second section.

Under condition (3), the number of first reflected light points not positioned within the corresponding theoretical position region among the current image frames is greater than the tenth threshold T10.

If the gaze tracking is failed, an operation for subsequent image frames within the current cycle is not performed any further, and operation S1410 is performed by jumping directly to the next cycle. If the gaze tracking succeeds, operation S1418 is performed. For example, a gaze direction for the current image frame is determined. Because the process of determining the gaze direction has already been described with reference to FIG. 13 above, the overlapping descriptions are omitted.

In operation S1413, if the current image frame is selected as the decoding frame, the reflected light point position of each first reflected light point of the current image frame is updated by performing operation S1417. In the example of FIG. 14B, because the third frame is selected as a decoding frame and the fourth frame is not selected as a decoding frame, the reflected light point positions are updated in the fourth frame. The updating process is the same as the process of updating the reflected light point positions of each first reflected light point of the decoding frame. After operation S1417 is completed, operation S1418 is performed to determine a gaze direction for the current image frame.

After operation S1418 is performed, operation S1419 is performed. For example, it is determined whether there is an unprocessed image frame in the current cycle. If an unprocessed image frame exists, operation S1412 is performed, and if there is no unprocessed image frame, operation S1410 is performed for the next cycle.

In the method described above, when only a small number of reflected light points are detected, the gaze direction may be regressed by using the reflected light point information of the small number of reflected light points, and even in a situation where only one reflected light point exists, the gaze direction may be regressed by using the reflected light point information of the only one reflected light point.

In the method of determining the gaze direction described above, after determining the reflected light point number of each reflected light point through a decoding frame, the gaze direction may be determined based on a regression model using the reflected light point information including the reflected light point number and the reflected light point position. However, According to one or more embodiments, the gaze direction may be determined using another method, which will be described in detail below.

In one or more other embodiments, in operation S110, a plurality of image frames are acquired by decoding data acquired based on an event camera. Here, each image frame includes event data acquired based on at least a reflected light point signal captured by the event camera. Here, the reflected light point signal denotes that light emitted from a light source is reflected by the corneal surface. Because operation S110 has been described in detail above, overlapping descriptions are omitted.

In operation S120, reflected light point information is determined for each image frame among the plurality of image frames. Here, the reflected light point information includes a reflected light point position and/or a reflected light point number related to a pair of reflected light points determined based on the event data.

For example, operation S120 includes an operation of determining a pair of reflected light points corresponding to the light source in the current image frame, and an operation of determining reflected light point information of a first reflected light point among each pair of reflected light points. Here, the reflected light point position included in the reflected light point information indicates the pixel position of the first reflected light point in the current image frame.

For example, the operation of determining the pair of reflected light points corresponding to the light source in the current image frame includes an operation of determining a search region for detecting the pair of reflected light points in the current image frame, and an operation of determining the pair of reflected light points corresponding to the light source based on the polarity of the event point determined based on the event data within the search region.

In the process of determining the search region for detecting the reflected light point in the current image frame, first, a first vector B is set. Here, the first vector B is related to a frame interval between the current image frame and the image frame in which the gaze direction is previously determined (i.e., the image frame in which the gaze direction is determined or calculated using a second regression model described below). In one example, the first vector B is the frame interval. First, the first vector B is a value greater than or equal to the sixth threshold T6, and it is determined whether the first vector B is greater than or equal to the sixth threshold T6 for the first frame among the plurality of image frames acquired through operation S110. If the first vector 9B is less than the sixth threshold T6 and indicates that a distance between the current image frame and the image frame in which the gaze direction has been previously determined is relatively close, a designated region among the current image frames is set as the search region. Here, the designated region is a region covering an approximated approximate circle using the first reflected light point when the gaze direction has been determined previously. In other words, the designated region is a region near the first approximate circle using each of the first reflected light points in the image frames in which the gaze direction has been successfully determined previously among the current image frames, for example, may be a ring-shaped region, a circular region, or a square region covering the first approximate circle. However, embodiments are not limited thereto. If the first vector B is greater than or equal to the sixth threshold value T6, the entire region of the current image frame is set as a search region.

After the search region is determined, a pair of reflected light points corresponding to the light source is determined based on the polarity of the event point determined based on the event data among the search regions, and corresponding to above determination the reflected light point position of the first pair of reflected light points among each pair of reflected light points is determined. In one embodiment, the process of determining the reflected light point corresponding to the light source and the reflected light point position of the first reflected light point of each pair of reflected light points based on the polarity of the event point of the search region is the same as the process described above with reference to operations S850, S860, and S870, and therefore, a duplicate description is omitted. and thus overlapping descriptions are omitted.

After the reflected light point is determined, in operation S130, a gaze direction of each image frame is determined based on the reflected light point information. For example, in one or more other embodiments, the gaze direction may be determined by a gaze estimation method based on circle center regression. According to one or more embodiments, a regression model is defined that determines the gaze direction of the current image frame by inputting information of a first approximate circle (e.g., a radius and a position of the circle center) for all first reflected lights of the current image frame.

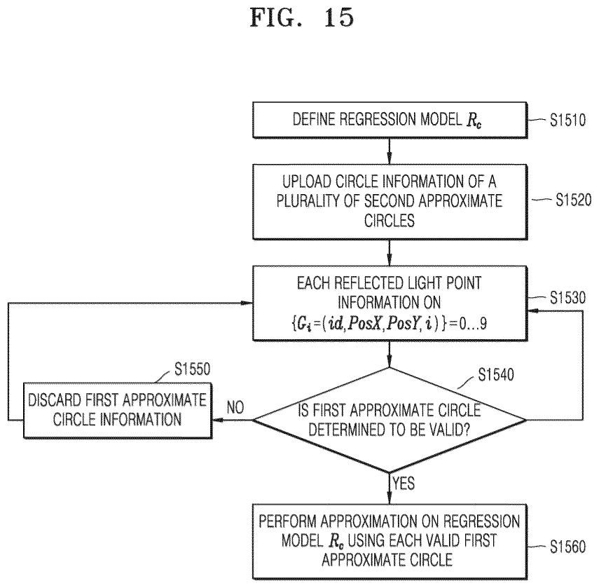

In this method, an offline approximation process must first be performed on the regression model. For example, as illustrated in FIG. 15, first, a regression model R_{c} is defined in operation S1510. Thereafter, in operation S1520, a circle center results (G_{c}=(PosX, PosY, r)) of a plurality of first approximate circles are uploaded. Here, r represents the radius of the first approximate circle, and both PosX and PosY represent circle information of the first approximate circle. In operations S1530 and S1540, for each first approximate circle's circle information (G_{c}=(PosX, PosY, r)), it is determined whether the first approximate circle is valid, and if the radius r of one first approximate circle is not −1 and is located in the first section, the first approximate circle may be regarded as valid, i.e., the circle information of the first approximate circle may be regarded as valid. Otherwise, the first approximation circle may be regarded as invalid. If one first approximation circle is determined to be valid, in operation S1560, the regression model R_{c} is approximated using the valid first approximation circle. That is, parameters of the corresponding regression model R_{c} are approximated. If one first approximation circle is determined to be invalid, in operation S1550, the circle information of the first approximation circle is discarded.

In one or more embodiments, the regression formula of the regression model is defined by the following Equation (13):

$$α = {p}^{T} q \qquad [ Equation 13 ]$$

Here, α is a vector of 1 row and 2 columns, representing a gaze direction, p is a matrix of 2 columns and 2 rows, representing a regression matrix, q is a vector of 2 rows and 1 column, recording a (x, y) coordinate of the center of the circle. By approximating the above regression formula, the parameters of the regression model may be finally obtained. Based on the parameters, the approximated regression model may be used, and a gaze direction may be determined based on the newly approximated approximate circle, which will be described in detail below.

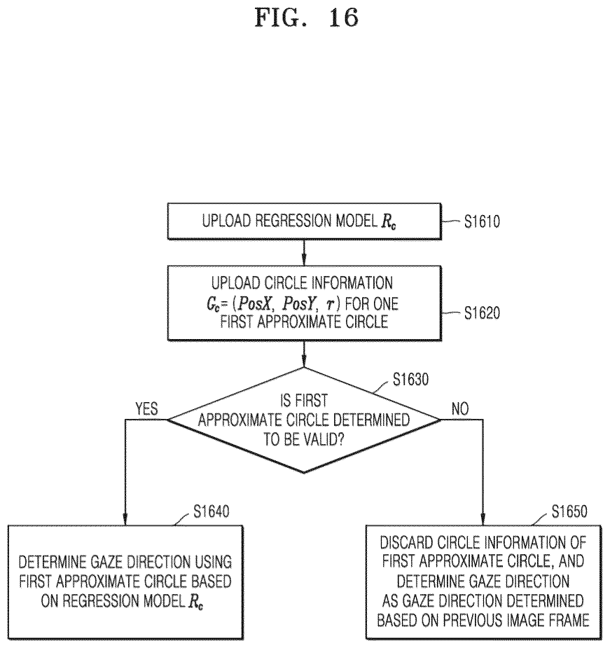

In one or more embodiments, the operation of determining the gaze direction for each image frame based on the reflected light point information may include an operation of obtaining a first approximate circle based on the reflected light point information of each first reflected light point among the current image frame, and an operation of determining a gaze direction of the current image frame using the first approximate circle based on the second regression model if the obtained first approximate circle is valid, or an operation of determining the gaze direction of the current image frame as the gaze direction of the previous image frame if the obtained first approximate circle is invalid. Hereinafter, the determination of a gaze direction will be described in detail with reference to FIG. 16.

As shown in FIG. 16, in operation S1610, an approximated regression model R_{c} (i.e., the second regression model) is uploaded. For example, the parameters of the regression model are uploaded.

Thereafter, in operation S1620, the circle information (G_{c}=(PosX, PosY, r)) of the first approximate circle is uploaded. Before uploading the circle information of the first approximate circle, the circle information of the first approximate circle must be obtained. For example, before determining the gaze direction of each image frame based on the reflected light point information, because the reflected light point information of all the first reflected light points (including the reflected light point position information of the first reflected light point) has already been determined in operation S120, the first approximate circle may be determined by approximating the first reflected light point of each pair of reflected light points among the current image frames. Because the approximation operation described above is the same as the approximation process described above with reference to FIG. 9, overlapping descriptions are omitted.

In operation S1630, the first approximate circle is determined to be valid. Because the judgment process described above is the same as the process of judging whether the approximate circle is valid described in operations S1530 and S1540, any redundant description will be omitted.

If the first approximate circle is determined to be valid, in operation S1640, a gaze direction is determined using the first approximate circle based on the described regression model R_{c} for the current image frame. For example, for the current image frame, the gaze direction is calculated using the regression model R_{c} that determines the parameters of the regression model by the equation 13. If the first approximate circle is determined to be invalid, in operation S1650, the circle information of the first approximate circle is discarded, and the gaze direction for the current image frame is determined as the gaze direction determined based on the previous image frame.

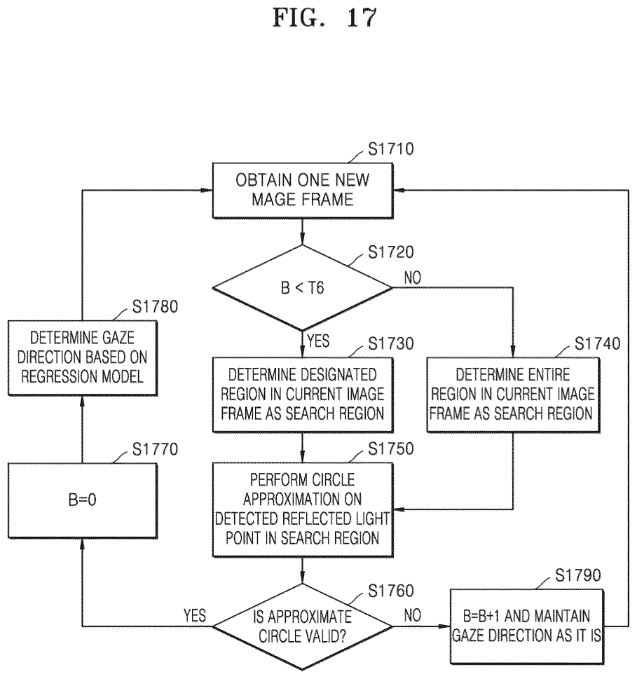

The method of determining the gaze direction using the center of the approximate circle based on the regression model has been described above. To facilitate understand the method, the entire process will be described below with reference to FIG. 17.

As shown in FIG. 17, in operation S1710, a new image frame is acquired. The newly acquired image frame is one of a plurality of image frames acquired in operation S110.

In operation S1720, it is determined whether the first vector B is less than the sixth threshold T6. If the first vector B is greater than or equal to the sixth threshold value T6, the process moves to operation S1740, sets the entire region of the current image frame to a search region, and moves to operation S1750. If the first vector B is less than the sixth threshold value T6, the process moves to operation S1750, determines the designated region of the current image frame as the search region, and moves to operation S1750. The designated region is a region covering an approximated approximate circle using the first reflected light point when determining the previous gaze direction.

In operation S1750, a pair of reflected light points is detected within the search region, and a first approximate circle is determined by performing a circle approximation on the first reflected light point of each detected pair of reflected light points. Because this has already been described in detail above, overlapping descriptions are omitted.

In operation S1760, it is determined whether the approximated first approximate circle is valid. If the first approximate circle is valid, in operation S1770, the first vector B is set to 0, and then operation S1780 is performed to determine a gaze direction using the first approximate circle based on a regression model (the process is the same as operation S1640 above), and then return to operation S1710 and process subsequent image frames. If the first approximate circle is determined to be invalid, in operation S1790, 1 is added to the first vector B and the gaze direction is maintained. For example, the gaze direction is determined as the gaze direction for the previous image frame. In addition, after discarding the circle information of the first approximate circle, the process returns to operation S1710 and processes subsequent image frames. In the method of determining the gaze direction described above, the gaze direction is determined by using the circle information of the approximate circle based on a regression model, but embodiments are not limited thereto, and the gaze direction may be determined by using another method, which is described in detail below.

In one or more other embodiments, in operation S110, data acquired by the event camera is decoded to acquire a plurality of image frames. Here, each image frame includes at least event data acquired based on a reflected light point signal in which light emitted from a light source captured by the event camera is reflected by the corneal surface. Because operation S110 has been described in detail above, overlapping descriptions are omitted.

In operation S120, reflected light point information is determined for each image frame among the plurality of image frames. Here, the reflected light point information includes reflected light point positions and/or reflected light point numbers related to the pair of reflected light points determined based on event data.

For example, operation S120 includes an operation of determining a pair of reflected light points corresponding to the light source in the current image frame, and an operation of determining reflected light point information of a first reflected light point among each pair of reflected light points. Here, the reflected light point position included in the reflected light point information indicates a pixel position of the first reflected light point in the current image frame.

In one or more embodiments, the operation of determining a pair of reflected light points corresponding to the light source in the current image frame may include an operation of determining a search region for detecting a pair of reflected light points in the current image frame, and an operation of determining the pair of reflected light points corresponding to the light source based on the polarity of the event points determined based on the event data within the search region. Here, through operations S820 to S840, a search region for detecting reflected light points in the current image frame may be determined, and through operations S850 and S860, the pair of reflected light points corresponding to the light source may be determined based on the polarity of the event points in the search region. Because the determination of the search region and the pair of reflected light points have already been described in detail above, overlapping descriptions are omitted. In addition, when determining the pair of reflected light points corresponding to a light source through operations S850 and S860, the reflected light point information of the first reflected light point among each reflected light point may be correspondingly determined.

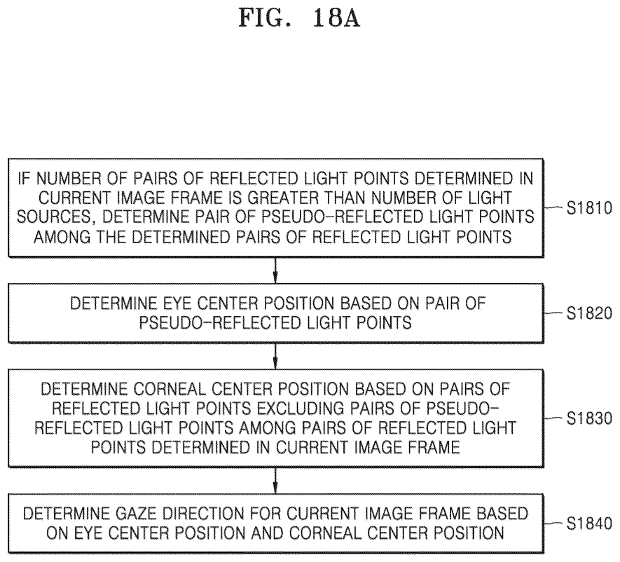

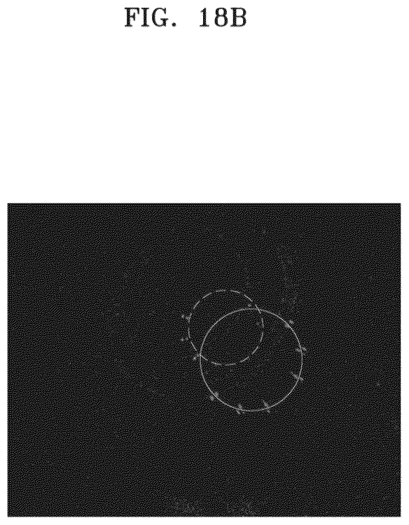

In operation S130, the gaze direction for each image frame is determined based on the reflected light point information. Among the pair of reflected light points of the current image frame determined through operations S850 and S860 above, a pair of pseudo-reflected light points may often exist, and in the method of determining the gaze direction through the decoding frame described above, the pair of pseudo-reflected light points is removed. However, here, the gaze direction may be determined by combining the pair of pseudo-reflected light points without removing the pseudo-reflected light points. This will be described below with reference to FIGS. 18A and 18B.

As shown in FIG. 18A, in operation S1810, if the number of pairs of reflected light points determined in the current image frame is greater than the number of light sources, the pair of pseudo-reflected light points is determined among the determined pairs of reflected light points. At this time, the pair of pseudo-reflected light points is determined based on event data obtained from a reflected light point signal reflected by the scleral sulcus surface. Because the process of determining the pseudo-reflected light point has been described in detail with reference to FIG. 9 above, overlapping descriptions are omitted.

In operation S1820, the eye center position is determined based on the pair of pseudo-reflected light points.

For example, the eye center position may be determined using the 3D coordinates of an LED light source, the 2D coordinates of the first reflected light point among the pair of pseudo-reflected light points, and the pose of a DVS camera based on the pupil center cornea reflection (PCCR) method.

In operation S1830, the corneal center position is determined based on the pair of reflected light points (hereinafter referred to as “non-pair of pseudo-reflected light points”) excluding the pair of pseudo-reflected light points among the pair of reflected light points determined in the current image frame.

For example, similar to operation S1820, the corneal center position may be determined using the 3D coordinates of the LED light source, the 2D coordinates of the first reflected light point among the non-pseudo-reflected light points, and the pose of the DVS camera based on the PCCR method.

In operation S1840, the gaze direction for the current image frame is determined based on the eye center position and the corneal center position. For example, because Kappa is fixed for a specific person, the gaze direction may be determined based on the eye center position and the corneal center position.

As shown in FIG. 18B, the reflected light point located in a relatively small circle is a first reflected light point among the non-pair of pseudo-reflected light points, and the reflected light point located in a relatively large circle is the first reflected light point among the pair of pseudo-reflected light points, and through these two types of reflected light points, the gaze direction may be determined using operations S1820 to S1840. In addition, because the eye center position is relatively fixed at some time, it is unnecessary to frequently guess the eye center position in this method.

Although the method of determining the gaze direction for the current image frame based on the eye center position and the corneal center position has been described above, the methods of determining the gaze direction described above may be combined.

For example, in the method described with reference to FIGS. 1 to 14B, if none of the first frame and the second frame satisfies the requirements in operation S520 in FIG. 5, the process returns directly to operation S510. For example, the processing for subsequent frames of the current cycle is no longer performed and the processing is performed by jumping to the next cycle. However, embodiments are not limited thereto, and if it is determined that none of the first frame and the second frame satisfies the requirements, in the present embodiment, the gaze direction for the current image frame may be determined by combining the methods described with reference to FIGS. 15 to 17 as described above.

In one or more embodiments, in the method described with reference to FIGS. 1 to 14B, the operation of determining the gaze direction for each image frame based on the reflected light point information in operation S130 may include an operation of repeating, if none of the first frame and the second frame satisfies the requirements, for each image frame among the image frame sets, if the first approximate circle obtained based on the reflected light point information of the current image frame is valid, an operation of determining a gaze direction for the current image frame using the first approximate circle based on the second regression model, and if the first approximate circle is invalid, an operation of determining the gaze direction for the current image frame as the gaze direction for the previous image frame.

For example, if none of the first frame and the second frame satisfies the requirement, the gaze direction of the first frame and the second frame is determined by selecting a different method based on whether the first approximate circle obtained by performing circle approximation is valid based on the reflected light point information of the first frame or the second frame. For example, if none of the first frame and the second frame satisfies the requirement but the first approximate circle obtained by performing circle approximation based on the reflected light point information of the first frame is valid (i.e., a radius is located within the first section), the gaze direction for the first frame may be determined using the center position of the first approximate circle based on the second regression model. If the first approximate circle obtained by performing circle approximation based on the reflected light point information of the first frame is invalid, the gaze direction for the first frame may be determined as the gaze direction for the previous image frame (e.g., the gaze direction for the last image frame of the previous cycle). Similarly, after processing the first frame that does not satisfy the requirement, in the second frame, if the second frame also does not satisfy the requirement but the first approximate circle obtained by performing circle approximation based on the reflected light point information of the second frame is valid (i.e., the radius is within the first section), the gaze direction for the second frame may be determined using the center position of the first approximate circle based on the second regression model. If the first approximate circle obtained by performing circle approximation based on the reflected light point information of the second frame is invalid, the gaze direction for the second frame may be determined as the gaze direction for the first frame. In addition, after the first frame and the second frame are processed, the gaze direction is determined using a similar method for other image frames of the current cycle.

By any one of the various gaze direction determination methods described above, the gaze direction may be determined for the current image frame. Based on these methods, one or more embodiments are directed to an interaction method.

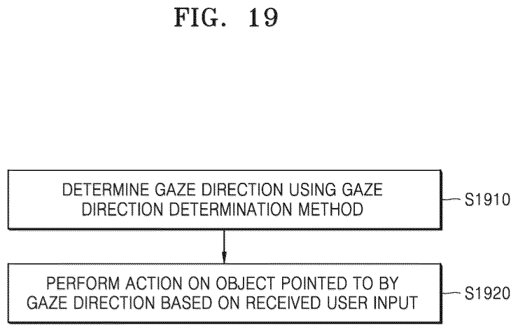

FIG. 19 is a flowchart illustrating an interaction method according to one or more embodiments.

As illustrated in FIG. 19, in operation S1910, a gaze direction is determined using the gaze direction determination method described above. Because the method of determining a gaze direction has already been described in detail with reference to FIGS. 1 to 18B above, overlapping descriptions are omitted.

In operation S1920, an action is performed on an object pointed to by the gaze direction based on the received user input. The user input may be at least one of a click input or a touch input on a smart ring, a voice input, a gesture input, and an eye blink input.

For example, in a human-computer interaction system of XR-based glasses applying the aforementioned interaction method According to one or more embodiments, after determining the gaze direction of the XR-based glasses through the aforementioned operation S1910, and then, a subsequent operation may be performed based on operation S1920. For example, rendering of different resolution can be performed based on a region pointed by the gaze direction. For example, it may be determined which region to be rendered in high resolution and which region to rendered in low resolution. For example, the region selected by the gaze direction may be rendered in high resolution, and the other region may be rendered in low resolution. For another example, after determining the gaze direction using the aforementioned gaze direction determination method, a confirmation operation for an object or button pointed by the gaze direction may be performed using another method.

For example, a user input may be performed by at least one of the methods below, and a confirmation action may be performed on an object pointed by the gaze direction.

According to one or more embodiments, a method of performing an input using a ring or other smart ring, for example, a confirmation action may be implemented by clicking a smart ring, a smart ring plane may be used as a touch panel (or touch screen) and a touch input, for example, a mouse-like sliding (for example, sliding left, right, up, or down) and a double-click, one-click action, may be performed, or an inertial measurement unit (IMU) is embedded in the smart ring and data (for example, data such as acceleration, angular velocity, etc.) is measured through the IMU.

According to one or more embodiments, a method of blinking the left eye or the right eye, detecting the blinking, and performing a confirmation action based on the detection result.

According to one or more embodiments, a method of performing a confirmation action using voice.

According to one or more embodiments, a method of performing a confirmation action using a specific gesture action.

According to one or more embodiments, a method of performing a confirmation action using another control button (e.g., a button on a game control handle).

Because, in the method according to one or more embodiments, a gaze direction is determined using only a DVS camera, and thus, very low power consumption may be implemented. Because the processing speed of the method of determining a gaze direction according to one or more embodiments is relatively very high (the processing speed may exceed 1000 frames/second), the gaze direction may be more quickly determined and relatively high accuracy may be obtained. In addition, in the CSI-based DVS camera, output data may be converted into a format of a frame image, and then processing may be performed using the method according to one or more embodiments. In addition, the method according to one or more embodiments may more accurately extract the reflected light points even for discrete frame-type events. In addition, in the method according to one or more embodiments (i.e., the large-weighted circle approximation method), pseudo-reflected light points may be more quickly and accurately detected and removed, and noise events may be removed well. In addition, in the problem of decoding errors in the reflected light point numbers of the reflected light points, the method according to one or more embodiments may more quickly and accurately determine whether the gaze tracking is failed, and thus, the gaze tracking has more robustness. In addition, in the method according to one or more embodiments, the gaze direction may be determined based on a plurality of regression models, and the problem of inaccurate gaze caused by missing reflected light points may be effectively solved. In addition, According to one or more embodiments, the eye center position may be determined using the pseudo-reflected light points without removing the pseudo-reflected light points, and the gaze direction may be determined by combining the corneal center position determined based on the non-pseudo-reflected light points. In addition, according to one or more embodiments, Luban's gaze estimation may be implemented by determining the gaze direction based on the method of regressing the center of an approximate circle.

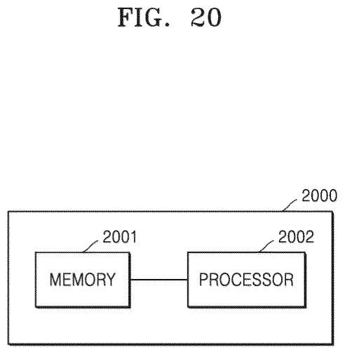

FIG. 20 is a block diagram of an electronic device 2000 according to one or more embodiments.

Referring to FIG. 20, the electronic device 2000 may include at least one memory 2001 and at least one processor 2002. The at least one memory 2001 stores computer-executable instructions, and when the computer-executable instructions are executed by the at least one processor 2002, the at least one processor 2002 performs the gaze direction determination method according to one or more embodiments.

For example, the electronic device 2000 may be a personal computer (PC) computer, a tablet device, a personal digital assistance (PDA), a smart phone, or any device capable of performing a combination of the above instructions. Here, the electronic device 2000 need not necessarily be a single electronic device, but may be any device or collection of circuits capable of performing the above instructions (or set of instructions) alone or in combination. The electronic device 2000 may also be part of an integrated control system or system manager, or may be a portable electronic device connected to an interface locally or remotely (e.g., via wireless transmission).

The processor may include a central processing unit (CPU), a graphics processing unit (GPU), a programmable logic unit, a dedicated processor system, a microcontroller, or a microprocessor. For example, the processor 2002 may further include an analog processor, a digital processor, a microprocessor, a multicore processor, a processor array, a network processor, and the like. However, embodiments are not limited thereto.

The processor 2002 may execute instructions or codes stored in the memory 2001, and the memory 2001 may further store data. The instructions and data may be transmitted and received over a network by a network interface device, and the network interface device may use any related transmission protocol.

The memory 2001 may be integrated with the processor 2002, for example, RAM or flash memory may be arranged within a microprocessor of an integrated circuit. In addition, the memory 2001 may further include an external disk drive, a memory array, or other storage devices that may be used in any database system. The memory 2001 and the processor 2002 may be operatively coupled, or the processor 2002 may read documents stored in the memory 2001 by communicating with each other through, for example, an I/O interface, a network connection, etc.

Additionally, the electronic device 2000 may further include a video display (e.g., a liquid crystal display) and a user interaction interface (e.g., a keyboard, a mouse, a touch input device, etc.). All elements of the electronic device 2000 may be interconnected by a bus and/or a network.

According to one or more embodiments, a non-transitory computer-readable storage medium storing a command is further provided. When the command is executed by at least one processor, the at least one processor performs the method of determining a gaze direction according to one or more embodiments. Examples of non-transitory computer-readable storage media herein may include read-only memory (ROM), programmable read-only memory (PROM), electrically erasable ROM (ROM), random access memory (DRAM), dynamic random access memory (DRAM), static random access memory (SRAM), flash memory, nonvolatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, blue-ray or optical disc memory, hard disk drive (HDD), solid state drive (SSD), card-type memory (e.g., multi-media-card, secure digital (SD) card, or extreme digital (XD) card), tape, floppy disk, magneto-optical data storage device, optical data storage device, hard disk, SSD and any other device. Any of the above other devices are configured to store a computer program and any associated data, data files and data structures in a non-transitory manner and provide the computer program and any associated data, data files and data structures to the processor or computer so that the processor or computer may execute the computer program. The instructions or computer programs of the above computer-readable storage medium may be executed in an environment disposed in a computer device such as a user terminal, a host, an agent device, a server, etc., and in one example, the computer program and any associated data, data files and data structures may be distributed on a computer system of the Internet, so that the computer program and any associated data, data files and data structures may be stored, accessed and executed in a distributed manner through one or more processors or computers.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. A method of determining a gaze direction, the method comprising:
obtaining a plurality of image frames by performing decoding based on data acquired by an event camera;
determining reflected light point information for each image frame among the plurality of image frames; and
determining the gaze direction for each image frame among the plurality of image frames based on the reflected light point information,
wherein each image frame among the plurality of image frames comprises:
event data obtained based on a reflected light point signal captured by the event camera, the reflected light point signal being light that is emitted from a light source and is reflected by a corneal surface, and
wherein the reflected light point information comprises at least one of a reflected light point position and numbers of reflected light points corresponding to a pair of reflected light points obtained based on the event data.

2. The method of claim 1, wherein the event camera comprises a dynamic vision sensor (DVS) camera based on camera parallel interface (CPI).

3. The method of claim 1, wherein the determining of the reflected light point information for each image frame among the plurality of image frames comprises:
determining a first frame among a set of image frames included in a same cycle based on time information corresponding to the plurality of image frames;
sequentially obtaining whether one image frame among the first frame and a second frame of the plurality of image frames satisfies a requirement; and
determining the reflected light point information for each image frame among the plurality of image frames after the one image frame among the set of image frames, based on the one image frame among the first frame and the second frame satisfying the requirement.

4. The method of claim 3, wherein the sequentially determining whether the one image frame among the first frame and the second frame satisfies the requirement of an image frame set comprises:
detecting a pair of reflected light points corresponding to the light source from the first frame;
based on a first approximate circle approximated to the pair of reflected light points of the first frame being valid and a number of pairs of the reflected light points of the first frame being greater than or equal to a first threshold, determining that the first frame satisfies the requirement;
based on determining the first frame does not satisfy the requirement, detecting a pair of reflected light points corresponding to the light source from the second frame of the image frame set; and
based on the first approximate circle approximated to a pair of reflected light points of the second frame being valid and a number of the pairs of reflected light points of the second frame being greater than or equal to a second threshold, determining that the second frame satisfies the requirement.

5. The method of claim 3, wherein, based on the reflected light point information, the determining of the gaze direction for each image frame comprises:
based on none of the first frame and the second frame satisfying the requirement, for each image frame among the image frame set,
based on a first approximate circle obtained based on the reflected light point information of a current image frame being valid, determining the gaze direction for the current image frame based on the first approximate circle based on a second regression model, and
based on the first approximate circle being invalid, determining the gaze direction for the current image frame as the gaze direction for a previous image frame.

6. The method of claim 3, wherein, based on the time information corresponding to the plurality of image frames, the determining of the first frame among the plurality of image frames included in the same cycle comprises:
based on the time information of the current image frame being greater than the time information of the next image frame or a time interval between a current image frame and a next image frame being greater than a third threshold, determining the next image frame as the first frame among the image frame set.

7. The method of claim 4, wherein the detecting of the pair of reflected light points corresponding to the light source from the first frame comprises:
based on a pair of reflected light points corresponding to the number of light sources being not detected from a previous image frame of a current image frame, detecting the pair of reflected light points corresponding to the light source in the current image frame, and
wherein the current image frame is the first frame or the second frame.

8. The method of claim 1, wherein the determining of the reflected light point information for each image frame among the plurality of image frames comprises:
determining a pair of reflected light points corresponding to the light source in a current image frame; and
determining the reflected light point information of a first reflected light point among each pair of reflected light points,
wherein the reflected light point position corresponds to a pixel position of the first reflected light point in the current image frame.

9. The method of claim 8, wherein, based on the reflected light point information, the determining of the gaze direction for each image frame comprises:
obtaining a first approximate circle based on the reflected light point information of each first reflected light point in the current image frame;
based on the obtained first approximate circle being valid, determining the gaze direction for the current image frame based on the first approximate circle based on a second regression model; and
based on the obtained first approximate circle being invalid, determining the gaze direction for the current image frame as the gaze direction for a previous image frame.

10. The method of claim 8, wherein the determining of the gaze direction for each image frame based on the reflected light point information comprises:
based on a number of pairs of reflected light point determined in the current image frame being greater than a number of light sources, determining a pair of pseudo-reflected light points among the pairs of determined reflected light points;
determining an eye center position based on the pair of pseudo-reflected light points;
determining a corneal center position based on a pair of reflected light points other than the pair of pseudo-reflected light points among the pairs of reflected light points determined in the current image frame; and
determining the gaze direction for the current image frame based on the eye center position and the corneal center position,
wherein the pair of pseudo-reflected light points is determined based on event data obtained from a reflected light point signal reflected by a scleral sulcus surface.

11. The method of claim 8, wherein the detecting of a pair of reflected light points corresponding to the light source in the current image frame comprises:
determining a search region configured to detect a pair of reflected light points in the current image frame; and
determining a pair of reflected light points corresponding to the light source based on a polarity of an event point determined based on the event data included in the search region.

12. The method of claim 11, wherein the determining of the pair of reflected light points corresponding to the light source based on the polarity of event points determined based on the event data within the search region comprises:
performing noise removal on the event points included in the search region; and
determining a pair of reflected light points corresponding to the light source included in the search region from which the noise was removed based on polarity statistics results of the event points included in the search region from which the noise was removed.

13. The method of claim 12, wherein the determining of the pair of reflected light points corresponding to the light source included in the search region from which the noise was removed, based on the polarity statistics results of the event points within the search region from which the noise was removed, comprises:
in the search region from which the noise was removed, for the event points having a first polarity, based on a number of event points having the first polarity included in the first region comprising the event points being greater than or equal to a fourth threshold and a number of event points having a second polarity included in a second region comprising the event points being greater than or equal to a fifth threshold, determining an average position of the event points having the first polarity within a third region comprising the event points as the position of the reflected light point of the first reflected light point among the reflected light point pairs; and
deleting the event points from a fourth region comprising the position,
wherein the first region is greater than or equal to the second region, and the position of the reflected light point of the first reflected light point corresponds to the pixel position of the first reflected light point in the current image frame.

14. The method of claim 11, wherein the determining of the search region configured to detect a pair of reflected light points in the current image frame comprises:
based on a pair of reflected light points being detected from a previous image frame of the current image frame, setting a region adjacent to the detected pair of reflected light points in the current image frame as the search region; and
based on no pair of reflected light points being detected from the previous image frame of the current image frame, setting an entire region of the current image frame as the search region.

15. The method of claim 11, wherein the determining of the search region configured to detect a pair of reflected light points in the current image frame comprises:
based on a first vector being greater than or equal to a sixth threshold, setting an entire region of the current image frame as the search region;
based on the first vector being less than or equal to the sixth threshold, setting a designated region of the current image frame as the search region,
wherein the first vector corresponds to a frame interval between the current image frame and an image frame in which the gaze direction is previously determined, and
wherein the designated region corresponds to an approximate circle approximated based on the first reflected light point when previously detecting the gaze direction.

16. The method of claim 11, wherein the detecting of a pair of reflected light points corresponding to the light source among the current image frame comprises:
based on a number of pairs of reflected light points determined in the current image frame being greater than the number of light sources, determining a pair of pseudo-reflected light points among the determined pairs of reflected light points;
removing the pairs of pseudo-reflected light points; and
determining the pairs of pseudo-reflected light points based on event data obtained from reflected light point signals reflected by the scleral sulcus surface.

17. The method of claim 10, wherein the determining of a pair of pseudo-reflected light points among the determined pairs of reflected light points comprises:
obtaining a first approximate circle by performing a circle approximation operation based on the reflected light point information of the first reflected light point among each pair of reflected light points of the current image frame;
determining a first distance between the first reflected light point of each pair of reflected light points of the current image frame and the first approximate circle; and
determining a pair of reflected light points corresponding to the first reflected light point having a first distance greater than a seventh threshold as the pair of pseudo-reflected light points.

18. An interaction method comprising:
determining a gaze direction based on a method comprising:
obtaining a plurality of image frames by performing decoding based on data acquired by an event camera;
determining reflected light point information for each image frame among the plurality of image frames; and
determining the gaze direction for each image frame among the plurality of image frames based on the reflected light point information,
wherein each image frame among the plurality of image frames comprises:
event data obtained based on a reflected light point signal captured by the event camera, the reflected light point signal being light that is emitted from a light source and is reflected by a corneal surface,
wherein the reflected light point information comprises at least one of a reflected light point position and numbers of reflected light points corresponding to a pair of reflected light points obtained based on the event data; and
performing an action for an object corresponding to the gaze direction based on receiving a user input.

19. The interaction method of claim 18, wherein the user input comprises at least one of:
a click input or a touch input on a smart ring;
a voice input;
a gesture input; and
an eye blink input.

20. An electronic device comprising:
at least one processor;
at least one memory configured to store computer-executable instructions,
wherein, when the computer-executable instructions are executed by the at least one processor, the at least one processor is configured to perform a method comprising:
obtaining a plurality of image frames by performing decoding based on data acquired by an event camera;
determining reflected light point information for each image frame among the plurality of image frames; and
determining a gaze direction for each image frame among the plurality of image frames based on the reflected light point information,
wherein each image frame among the plurality of image frames comprises:
event data obtained based on a reflected light point signal captured by the event camera, the reflected light point signal being light that is emitted from a light source and is reflected by a corneal surface,
wherein the reflected light point information comprises at least one of a reflected light point position and numbers of reflected light points corresponding to a pair of reflected light points obtained based on the event data.
